(19) United States
(12) Patent Application Publication
(10) Pub. No.: US 2025/0148345 A1
(43) Pub. Date: May 8, 2025

(54) METHODS AND SYSTEMS FOR CHARACTERIZATION AND CALIBRATION OF A QUANTUM PROCESSOR

(71) Applicant: QEDMA Quantum Computing LTD., Tel-Aviv (IL)

(72) Inventors: Itsik COHEN, Ramat Gan (IL); Adiel Reuvan Meyer BERMAN, Tel-Aviv (IL); Eyal BAIREY, Tel Aviv (IL); Eyal LEVIATAN, Tel Aviv (IL); Omrie OVDAT, Pardesia (IL); Ilya GURWICH, Ramat-Gan (IL); Ron MELCER, Givataayim (IL); Yaron ITKIN, Tel Aviv (IL); Omri GOLAN, Rehovot (IL); Shlomi KOTLER, Givat Ram (IL); Netanel Hanan LINDNER, Aviel (IL)

(73) Assignee: QEDMA Quantum Computing LTD., Tel-Aviv (IL)

(21) Appl. No.: 18/896,453

(22) Filed: Sep. 25, 2024

Related U.S. Application Data
(60) Provisional application No. 63/596,702, filed on Nov. 7, 2023.

(51) Int. Cl. G06N 10/70; G06N 10/40

(52) U.S. Cl. CPC G06N 10/70; G06N 10/40

(57) ABSTRACT

A computer implemented method for characterizing at least one target error parameter of implementation errors in a quantum logic operation g acting on a targeted set of qubits of a quantum processor is presented. The method comprises: (a) generating at least one characterization sequence S configured for amplifying said at least one target error parameter, said at least one characterization sequence S comprises at least one refocusing sequence, wherein the at least one refocusing sequence is configured so that the characterization sequence reduces predefined generator terms including crosstalk between said targeted set of qubits and another set of qubits of the quantum processor; and (b) characterizing said at least one target error parameter using said at least one characterization sequence in a characterization protocol.

### TECHNOLOGICAL FIELD

The present disclosure relates to the field of quantum computing, specifically to the field of quantum processor characterization.

### BACKGROUND

The development of useful quantum computers relies crucially on the reduction of implementation errors-differences between the actual and ideal implementations of quantum logic operations. The long-term strategy for dealing with such errors is quantum error correction, which, however, requires very low error rates to begin with, as well as an excessive overhead in the number of qubits, relative to existing hardware. Complementary strategies, suited for dealing with errors in small circuits on existing hardware, are collectively termed quantum error suppression and mitigation. Yet, the first stage of reducing implementation errors is basically the calibration of quantum logic operations (gates). The improvement of hardware to meet the conditions for error correction, together with the majority of error suppression and mitigation and calibration protocols, require a detailed and high-resolution characterization of implementation errors. Though the characterization of implementation errors in single qubits or qubit pairs is common practice, it is widely understood as computationally intractable for more than just a few qubits-unless various simplifying and often un-realistic assumptions are made. This state of affairs prevents the detailed and high-resolution characterization of state-of-the-art quantum processors, currently numbering tens to hundreds of qubits.

### GENERAL DESCRIPTION

Characterization protocols known in the art have a deficiency of inability to select a desired set of error parameters to characterize, causing inefficiency in the required run time. For example, in characterization protocols that use error amplification to characterize errors, when a gate is repeated to amplify a desired error parameter, additional error parameters are amplified as well. This leads to systematic errors in the characterization, unless these additional parameters are characterized as well. Characterizing the additional parameters leads to intractable time requirement in the presence of crosstalk. Thus, characterization protocols known in the art also have a deficiency of inability to account for crosstalk between qubits. leading to systematic errors in the characterization.

The present disclosure provides a characterization protocol, wherein a desired set of error parameters to characterize can be selected. Furthermore, a characterization protocol as disclosed herein accounts for crosstalk between qubits, thereby reducing the systematic errors in the characterization.

In accordance with a first aspect of the presently disclosed subject matter, there is provided a computer implemented method, for characterizing at least one target error parameter of implementation errors. The implementation errors are in a quantum logic operation g acting on a targeted set of qubits of a quantum processor. The method includes generating at least one characterization sequence S. The at least one characterization sequence S is configured for amplifying the at least one target error parameter. The at least one characterization sequence S comprises at least one refocusing sequence. The at least one refocusing sequence is configured so that the at least one characterization sequence reduces predefined generator terms. The predefined generator terms include crosstalk between the targeted set of qubits and another set of qubits of the quantum processor. The method includes characterizing the at least one target error parameter, using the at least one characterization sequence in a characterization protocol.

According to some embodiments, characterizing the at least one target error parameter includes applying the at least one characterization sequence S to the quantum processor. Characterizing the at least one target error parameter includes measuring the targeted set of qubits using a measurement apparatus of said quantum processor, thereby obtaining a set of measurement values. Characterizing the at least one target error parameter includes computing a value of the at least one target error parameter, by fitting a model to the set of measurement values.

In addition to the above features, a computer implemented method for characterizing at least one target error parameter, according to this aspect of the presently disclosed subject matter, can optionally comprise one or more of features (i) to (xxxvii) below, in any technically possible combination or permutation:
i. the at least one characterization sequence S is configured for reducing predefined coherent error generator terms in the targeted set of qubits.
ii. the at least one refocusing sequence is a dynamical decoupling sequence.
iii. the at least one refocusing sequence is a twirling sequence.
iv. the at least one target error parameter is a Pauli generator term Pₜ.
v. the at least one characterization sequence S is configured to eliminate predefined Pauli generator terms of the implementation errors distinct from the at least one target error parameter.
vi. the method characterizes a single target error parameter of implementation errors in the quantum logic operation g.
vii. the at least one characterization sequence S is configured to reduce a magnitude measure of the crosstalk.
viii. the at least one characterization sequence S is configured to eliminate at least a first-order error of implementation errors distinct from the at least one target error parameter.
ix. the at least one characterization sequence S is configured for characterizing dissipation implementation errors. The dissipation implementation errors being any one of Markovian dissipation implementation errors, and non-Markovian dissipation implementation errors.
x. recompiling the at least one characterization sequence S.
xi. the at least one characterization sequence S includes at least one germ.
xii. the at least one germ is a recursively concatenated germ.
xiii. the at least one refocusing sequences includes a set of refocusing sequences. The at least one characterization sequence S includes a recursively concatenated germ obtained by computing a predefined number n of concatenations Gₖ₊₁=ΠₘGₖβₘ^{(k)}, wherein k=0, 1, . . . , n−1. βₘ^{(k)} are refocusing sequences of the set of refocusing sequences. G₀=g, g being said quantum logic operation.
xiv. the at least one characterization sequence S includes at least one fiducial operation.
xv. the at least one fiducial operation includes state preparation operations configured for setting a state of the set of qubits to a preparation Pauli state Pₚ. The at least one fiducial operation includes measuring the set of qubits according to a measurement Pauli Pₘ.
xvi. the preparation Pauli state Pₚ, measurement Pauli Pₘ, and the Pauli generator term Pₜ, span an algebra isomorphic to the SU(2) Lie algebra.
xvii. the preparation Pauli state Pₚ and measurement Pauli Pₘ are configured for increasing a sensitivity of the least one characterization sequence S to the at least one error parameter.
xviii. the at least one fiducial operation includes a gate layer.
xix. the at least one refocusing sequence commutes with the Pauli generator term Pₜ.
xx. the quantum logic operation g is a single-qubit operation.
xxi. the quantum logic operation g is a two-qubit operation, and a KAK decomposition of the quantum logic operation g includes any of one generator, two generators, and three generators.
xxii. the quantum logic operation g is a two-qubit operation. The Pauli generator term Pₜ anti-commutes with at least one generator of a KAK decomposition of an ideal version of said quantum logic operation g. A sum of coefficients is greater than

$$\frac{3 π}{4} ,$$

the coefficients corresponding to the at least one KAK generator anti-commuting with said Pauli generator term Pₜ. The at least one refocusing sequence includes at least one secondary refocusing sequence. The at least one secondary refocusing sequence commuting with all commutators of the Pauli generator term Pₜ and generators of the KAK decomposition of an ideal version of the quantum logic operation g.
xxiii. the Pauli generator term Pₜ is distinct from an over-rotation term. The recursively concatenated germ includes at least n concatenation steps. The at least one characterization sequence S is configured to eliminate a fraction of 1-2⁻ⁿ of Pauli generator terms of the implementation errors.
xxiv. the Pauli generator term Pₜ is distinct from an over-rotation term. A primary refocusing sequence anti-commutes with a corresponding Pauli generator term of an ideal version of the quantum logic operation g.
xxv. the Pauli generator term Pₜ is an over-rotation term. The recursively concatenated germ includes at least n concatenation steps. The at least one characterization sequence S is configured to eliminate a fraction of 1-2⁻⁽ⁿ⁺¹⁾ of Pauli generator terms of the implementation errors.
xxvi. the at least one characterization sequence S is configured to isolate the Pauli generator term Pₜ of the implementation errors.
xxvii. the at least one characterization sequence S includes any of the germs G₀⁽¹⁾=gA, and G₁⁽¹⁾=BG₀⁽¹⁾CG₀⁽¹⁾. The A, B, C being refocusing sequences.
xxviii. the at least one characterization sequence S includes any of the germs G₀⁽²⁾=gAgA, and G₁⁽²⁾=BG₀⁽²⁾CG₀⁽²⁾. The A, B, C being refocusing sequences.
xxix. the at least one characterization sequence S includes any of the germs G₀⁽³⁾=gAgA, G₁⁽³⁾=G₀⁽³⁾AG₀⁽³⁾A, G₂⁽³⁾=BG₁⁽³⁾CG₁⁽³⁾, and G₃⁽³⁾=G₁⁽³⁾BG₁⁽³⁾C. The A, B, C being refocusing sequences.
xxx. the at least one characterization sequence S includes refocusing sequences randomly sampled for each application of the at least one characterization sequence S.
xxxi. the Pauli generator term Pₜ is distinct from an over-rotation term. The at least one characterization sequence S includes at least one subsequence G⁽⁴⁾=PgDgDP. P being a randomly sampled Pauli operator. D being a refocusing sequence commuting with the Pauli generator term Pₜ, and anti-commuting with a corresponding Pauli generator term of an ideal version of the quantum logic operation g.
xxxii. the Pauli generator term Pₜ is an over-rotation term. The at least one characterization sequence S includes at least one subsequence G⁽⁵⁾=PgP. P being a randomly sampled Pauli operator, commuting with the Pauli generator term Pₜ.
xxxiii. the method is applied to at least two quantum logic operations in parallel.
xxxiv. the at least two quantum logic operations operate on corresponding subsets of qubits, the corresponding subsets of qubits have no common qubit.
xxxv. no crosstalk is present between each of said corresponding subsets of qubits.
xxxvi. each of the corresponding subsets of qubits is included in a corresponding hyperedge of an interaction hypergraph. Each of the corresponding hyperedges being unique for each of the corresponding subsets of qubits.
xxxvii. the quantum logic operation g is a gate layer or the at least one refocusing sequence includes a gate layer.

In accordance with a second aspect of the presently disclosed subject matter, there is provided a computer implemented method, for characterizing a quantum processor. The quantum processor includes a plurality of quantum logic operations. The method includes applying a method according to the first aspect of the presently disclosed subject matter, to at least one quantum logic operation that is included in the plurality of quantum logic operations of the quantum processor.

According to some embodiments, the quantum processor is described in terms of qudits in place of qubits.

In accordance with a third aspect of the presently disclosed subject matter, there is provided a non-transient computer-readable storage-medium storing computer instructions, wherein the computer instructions are used for causing a computer to execute the method according to the first or second aspects of the presently disclosed subject matter.

In accordance with a fourth aspect of the presently disclosed subject matter, there is provided a computer program product, comprising a computer program, wherein the computer program, when executed by a computer, implements the method according to the first or second aspects of the presently disclosed subject matter.

In accordance with a fifth aspect of the presently disclosed subject matter, there is provided a system comprising a computer and a quantum processor. The computer having gate-level or pulse-level access to the quantum processor. The system being configured to perform the method according to the first or second aspects of the presently disclosed subject matter.

In accordance with a sixth aspect of the presently disclosed subject matter, there is provided a system for characterizing implementation errors in a quantum logic operation g. The quantum logic operation g operates on a targeted set of qubits of a quantum processor. The system includes a processor configured for executing computer-executable components stored in a memory. The computer-executable components include a sequence component. The sequence component is configured for generating at least one characterization sequence. The at least one characterization sequence includes at least one refocusing sequence and the quantum logic operation g. The at least one characterization sequence is configured for amplifying at least one target error parameter. The at least one refocusing sequence is configured for reducing predefined crosstalk Pauli terms. The crosstalk is between the targeted set of qubits and another set of qubits of the quantum processor. The system includes a characterization component, configured for characterizing errors in the quantum logic operation g, using said sequence.

In addition to the above features, a system for characterizing implementation errors, according to this aspect of the presently disclosed subject matter, can optionally comprise one or more of features (i) to (vii) below, in any technically possible combination or permutation:
i. the at least one characterization sequence is configured for reducing predefined Pauli generator terms in the targeted set of qubits.
ii. the at least one refocusing sequence is a dynamical decoupling sequence.
iii. the at least one refocusing sequence is a twirling sequence.
iv. the at least one target error parameter is a Pauli generator term Pₜ.
v. the at least one refocusing sequence commutes with said Pauli generator term Pₜ.
vi. a first refocusing sequence included in the at least one characterization sequence anti-commutes with a Pauli generator term of an ideal version of the quantum logic operation g corresponding to the Pauli generator term Pₜ.
vii. the at least one refocusing sequence is configured to cut the link (eliminate crosstalk) between a targeted subset of qubits and its neighbors.

In accordance with a seventh aspect of the presently disclosed subject matter, there is provided a quantum circuit for use in characterizing implementation errors in a quantum logic operation g. The quantum logic operation g acts on a set of qubits. The quantum circuit includes the quantum logic operation g and at least one refocusing sequence. The quantum circuit is configured for amplifying at least one target error parameter. The at least one refocusing sequence is configured for reducing predefined terms of a crosstalk between the set of qubits and a set of spectator qubits of the quantum processor.

In addition to the above features, a quantum circuit for use in for characterizing implementation errors, according to this aspect of the presently disclosed subject matter, can optionally comprise one or more of features (i) to (x) below, in any technically possible combination or permutation:
i. the at least one characterization sequence is configured for reducing predefined generator terms in the targeted set of qubits.
ii. the at least one refocusing sequence is a dynamical decoupling sequence.
iii. the at least one refocusing sequence is a twirling sequence.
iv. the at least one target error parameter is a Pauli generator term Pₜ.
v. the Pauli generator term Pₜ is not an over-rotation Pauli generator term. The quantum circuit includes any of the germs G₀⁽¹⁾=gAgA, G₁⁽¹⁾=G₀⁽¹⁾AG₀⁽¹⁾A, G₂⁽¹⁾=BG₁⁽¹⁾CG₁⁽¹⁾, and G₃⁽¹⁾=G₁⁽¹⁾BG₁⁽¹⁾C. The A, B, C being refocusing sequences.
vi. the Pauli generator term Pₜ is an over-rotation Pauli generator term. The quantum circuit comprises any of the germs G₀⁽²⁾=gA, G₁⁽²⁾=gAgA, G₂⁽²⁾=BG₁⁽²⁾CG₁⁽²⁾, G₃⁽²⁾=BG₁⁽²⁾CG₁⁽²⁾. The A, B, C being refocusing sequences.
vii. including at least one recursively concatenated germ.
viii. the at least one refocusing sequences includes a set of refocusing sequences. The recursively concatenated germ is defined by a predefined number n of concatenations Gₖ₊₁=ΠₘGₖβₘ^{(k)}, wherein k=0, 1, . . . , n−1 and G₀=g. The βₘ^{(k)} are refocusing sequences included in the set of refocusing sequences.
ix. the Pauli generator term Pₜ is not an over-rotation Pauli generator term. The quantum circuit includes at least one subsequence G⁽³⁾=PgDgDP. P being a randomly sampled Pauli operator commuting with the Pauli term Pₜ. D being a refocusing sequence commuting with the Pauli generator term Pₜ, and anti-commuting with a corresponding Pauli generator term of an ideal version of the quantum logic operation g.
x. the Pauli generator term Pₜ is an over-rotation Pauli generator term. The quantum circuit includes at least one subsequence G⁽⁴⁾=PgP. P being a randomly sampled Pauli operator commuting with said Pauli term Pₜ.

In accordance with an eighth aspect of the presently disclosed subject matter, there is provided a computer implemented method for calibrating a quantum logic operation g. The quantum logic operation g acts on a targeted set of qubits of a quantum processor. The method includes obtaining at least one characterization value of the quantum logic operation g, by characterizing the quantum logic operation g. Characterizing the quantum logic operation g is performed using a method according to the first aspect of the presently disclosed subject matter. The method includes configuring the quantum logic operation g for performing a predefined action on the targeted set of qubits. Configuring the quantum logic operation g is performed by adjusting at least one pulse parameter of the quantum logic operation g, according to the at least one characterization value.

According to some embodiments, adjusting the at least one pulse parameter includes adjusting at least one of a pulse shape, a pulse amplitude, and a frequency spectrum.

According to some embodiments, configuring the quantum logic operation g includes correcting at least one implementation error in the quantum logic operation g.

In the present disclosure, the following terms and their derivatives may be understood according to the below explanations:

The term “operator” may refer to a mapping from a state-vector to a state-vector.

The term “super-operator” may refer to a mapping from a density-operator to a density-operator.

The terms “gate” and “quantum operation” may be synonyms.

The phrase “term”, when relating to generators of quantum logic operations or implementation errors, may refer to an element of a generator or to a summand in a series expansion. For example, a matrix element in a matrix representation, a summand in a perturbation expansion, or a Pauli matrix in an expansion according to Pauli matrices.

The term “Pauli term” may refer to a matrix included in the Pauli group [symbol] . The Pauli group is defined as the subgroup of the unitary group that includes tensor-products of the Pauli matrices, with possible multiplication by integral powers of the imaginary unit. In formula: [symbol] ₙ={±1,±i}×{Î, \hat{σ}ₓ, \hat{σ}_{y}, \hat{σ}_{z}}^{⊗n}. The number of qubits may be implicit, and the subscript may be omitted. A Pauli term may be used for representing both operators and super-operators.

The term “Pauli gate” may refer to any quantum gate that is represented by a matrix included in the Pauli group [symbol] .

The symbol ⊗ may denote the Kronecker-product.

Transposition operation may be denoted by a superscript T, e.g., H^{T}.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 illustrates a set of qubits interacting with another set of qubits.

FIG. 2 shows a flowchart illustrating a broad aspect of a method according to embodiments of the present disclosure.

FIG. 3A-3B illustrate features of refocusing sequences and characterization sequences according to embodiments of the present disclosure.

FIG. 4-5 illustrate properties of fiducial operations according to embodiments of the present disclosure.

FIG. 6 illustrates a recursively concatenated germ.

FIG. 7 illustrates features of recursively concatenated germs according to embodiments of the present disclosure.

FIG. 8 illustrates features of twirling subsequences according to embodiments of the present disclosure.

FIG. 9 illustrates properties of quantum logic operations and refocusing sequences according to embodiments of the present disclosure.

FIG. 10A-10C illustrate partitions of qubits according to embodiments of the present disclosure.

FIG. 11A-11C illustrate partitions of qubits according to other embodiments of the present disclosure.

FIG. 12 illustrates a flowchart diagram of a method according to embodiments of the present disclosure.

FIG. 13A-13B show graphs illustrating model-fitting in a method according to embodiments of the present disclosure.

FIG. 14 show graphs demonstrating the performance of a method for characterizing errors in a quantum processor, according to embodiments of the present disclosure, in comparison to methods for characterizing errors in a quantum processor, known in the art.

FIG. 15 schematically illustrates a computer implementing a method according to embodiments of the present disclosure.

FIG. 16 schematically illustrates a system implementing a method according to embodiments of the present disclosure.

### DETAILED DESCRIPTION OF EMBODIMENTS

Described herein are some examples of systems and methods useful for mitigating errors in quantum logic operations.

In the following detailed description, numerous specific details are set forth in order to provide a thorough understanding of the subject matter. However, it will be understood by those skilled in the art that some examples of the subject matter may be practiced without these specific details. In other instances, well-known methods, procedures and components have not been described in detail so as not to obscure the description.

As used herein, the phrases “for example,” “such as”, “for instance” and variants thereof describe non-limiting examples of the subject matter.

Reference in the specification to “one example”, “some examples”, “another example”, “other examples, “one instance”, “some instances”, “another instance”, “other instances”, “one case”, “some cases”, “another case”, “other cases” or variants thereof means that a particular described feature, structure or characteristic is included in at least one example of the subject matter, but the appearance of the same term does not necessarily refer to the same example.

It should be appreciated that certain features, structures and/or characteristics disclosed herein, which are, for clarity, described in the context of separate examples, may also be provided in combination in a single example. Conversely, various features, structures and/or characteristics disclosed herein, which are, for brevity, described in the context of a single example, may also be provided separately or in any suitable sub-combination.

Unless specifically stated otherwise, as apparent from the following discussions, it is appreciated that throughout the specification discussions utilizing terms such as “computing”, “determining”, “running”, “implementing”, “using”, “performing”, or the like, may refer to the action(s) and/or process(es) of any combination of software, hardware and/or firmware. For example, these terms may refer in some cases to the action(s) and/or process(es) of a programmable machine, that manipulates and/or transforms data represented as physical, such as electronic quantities, within the programmable machine's registers and/or memories into other data similarly represented as physical quantities within the programmable machine's memories, registers and/or other such information storage, transmission and/or display element(s).

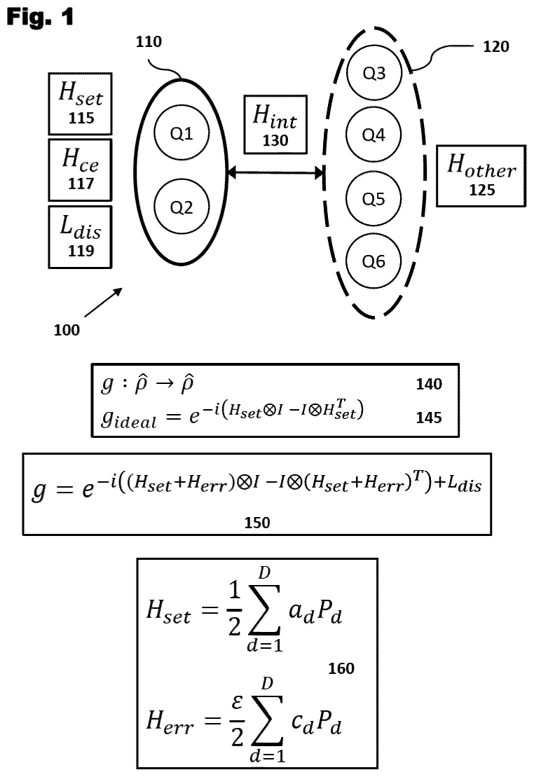

FIG. 1 illustrates some terms that may be used in the following description. A quantum processor 100 may include a plurality of qubits, e.g., six qubits numbered Q1 to Q6. Qubits Q1 Q2 may be included in a targeted set of qubits 110. Qubits Q3 to Q6 may be included in another set of qubits 120. The targeted set of qubits 110 may be interacting with the another set of qubits 120, the interaction being illustrated by a two-sided arrow.

A quantum logic operation g may be applied on the targeted set of qubits 110. The implementation of the quantum logic operation g may have errors, i.e., it may deviate from an intended ideal version of the quantum logic operation g_{ideal}. The errors (deviations) may be of multiple types. The errors may include coherent errors. For example, over-rotation. Over-rotation may be a rotation of the state of a set of qubits, through an angle different than an angle the quantum logic operation is configured to rotate. The errors may include incoherent, or dissipative, errors (e.g., T₁ and T₂ decay processes occurring during the operation g). The deviations may include errors due to interaction of the targeted set of qubits 110 with the another set of qubits 120. Errors due to this interaction may be referred to as “errors originating from crosstalk”, or as “crosstalk”.

The ideal version of the quantum logic operation g_{ideal} and the errors may be expressed by generators, i.e., by Hamiltonians and/or Lindbladians. The ideal version of the quantum logic operation g_{ideal} may have a generator Hₛₑₜ 115. The generators of errors may include a generator of coherent errors H_{ce} 117, a generator of dissipation errors L_{dis} 119, and a generator of crosstalk errors Hᵢₙₜ 130. Because of the crosstalk, the errors may depend on the state and time-evolution of the qubits of the another set of qubits 120. The generator of the time-evolution of the another set of qubits 120, excluding crosstalk, may be denoted as Hₒₜₕₑᵣ 125. The generators Hₛₑₜ 115, H_{ce} 117, L_{dis} 119 may act only on the targeted set of qubits 110. The generator Hₒₜₕₑᵣ 125 may be act only on the another set of qubits 120.

Every quantum operation and generator may be represented as a super-operator. However, some generators and quantum operation may be more conveniently represented as operators. A super-operator representation of an operator Ô may be obtained by Kronecker-products with an identity operator, i.e., the super-operator representation of an operator Ô may be Ô⊗I−I⊗ [symbol] .

The generators Hₛₑₜ 115, H_{ce} 117, Hₒₜₕₑᵣ 125, Hᵢₙₜ 130 may be represented as operators. The quantum logic operation g may be represented by a super-operator 140. The generator L_{dis} 119 may be represented as a super-operator. The sum of the H_{ce} 117, Hₒₜₕₑᵣ 125, Hᵢₙₜ 130 error generators may be denoted by Hₑᵣᵣ. The ideal version of the quantum logic operation g_{ideal} may be expressed as an exponent of the generator Hₛₑₜ 145. The expression for g_{ideal} 145 gives g_{ideal} in a super-operator representation. The quantum logic operation g may be expressed as an exponent of the sum of all the generators listed hereinabove 150.

The generators may be expanded as weighted sums of Pauli terms 160, i.e., as weighted sums of matrices included in the Pauli group [symbol] . The number of Pauli terms in the expansion may be denoted by D. Hₑᵣᵣ may have a magnitude quantified by a scale parameter ε, where the sum may have a unit-norm in a matrix-norm.

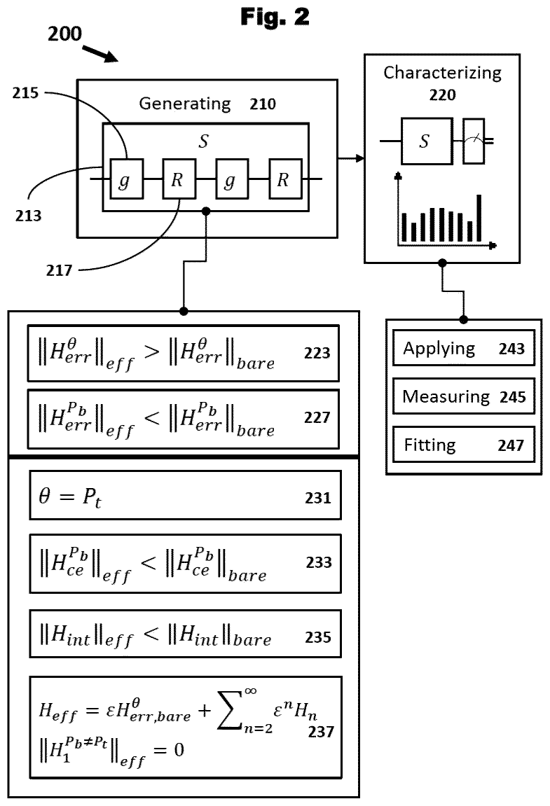

FIG. 2 shows a flowchart illustrating a broad aspect of a computer implemented method 200 for characterizing at least one target error parameter of implementation errors in a quantum logic operation g 215, according to embodiments of the present disclosure.

The quantum logic operation g 215 may act on a targeted set of qubits of a quantum processor. The quantum logic operation g 215 may be noisy, i.e., it may deviate from an intended ideal operation g_{ideal}. This deviation may include coherent errors

$$( e . g . , a \frac{π}{2} -$$

rotation gate may rotate the state of a qubit through an angle different than

$$\frac{π}{2} )$$

and incoherent, or dissipative, errors (e.g., T₁ and T₂ decay processes occurring during the operation g 215). The implementation errors may be quantified by an at least one error parameter. In other words, the implementation errors may be modelled by a model that may include at least one error parameter. The at least one target error parameter may be denoted θ. The at least one target error parameter θ may relate to any type of error, i.e., the at least one target error parameter θ may relate to at least one of the coherent error generator H_{ce}. dissipative error generator L_{dis}, or crosstalk error generator Hᵢₙₜ.

The method 200 may comprise a step of generating at least one characterization sequence S 210. The at least one characterization sequence S 213 may include at least one instance of the quantum logic operation g 215. The at least one characterization sequence S 213 may be configured for amplifying the at least one target error parameter θ 223. In other words, the at least one characterization sequence S 213 may be configured for acting on the targeted set of qubits, so as to have an implementation error that relates to the at least one target error parameter θ, that is greater than the implementation error of the quantum logic operation g 215. In yet other words, the Hₑᵣᵣ may have an effective value, when the quantum logic operation g 215 is included in at least one characterization sequence S 213. The effective value may be different from the bare value (i.e., when the quantum logic operation g 215 is applied alone). At least one term (e.g., a Pauli term) of the effective Hₑᵣᵣ, that may relate to the at least one target error parameter θ, may have a greater value than the bare Hₑᵣᵣ.

The at least one characterization sequence S 213 may include at least one refocusing sequence R 217. Generally, a refocusing sequence may be defined as a sequence of quantum operations that may be configured for controllably amplifying a first set of implementation errors, while concurrently, attenuating a second set of implementation errors.

The at least one refocusing sequence R 217 may be configured so that the at least one characterization sequence S 213 may reduce predefined error generator terms P_{b} 227. The predefined error generator terms P_{b} may include crosstalk between the targeted set of qubits and another set of qubits of the quantum processor. That is, predefined terms of Hₑᵣᵣ may have an effective value less than the bare value. In other words, the at least one refocusing sequence R 217 may be configured so predefined terms (e.g., Pauli terms) of Hₑᵣᵣ may have an effective value less than the bare value. The predefined terms of Hₑᵣᵣ, that may have an effective value less than the bare value, may be distinct from the at least one term of the effective Hₑᵣᵣ, that may relate to the at least one target error parameter θ.

The method 200 may comprise a step of characterizing the at least one target error parameter θ 220. Characterizing the at least one target error parameter θ 220 may be performed using said at least one characterization sequence S 213 in a characterization protocol (e.g., gate set tomography).

The step of characterizing the at least one target error parameter θ 220 may include applying the at least one characterization sequence S to the quantum processor 243. The step of characterizing the at least one target error parameter θ 220 may include measuring the targeted set of qubits using a measurement apparatus of the quantum processor, thereby obtaining a set of measurement values 245. The step of characterizing the at least one target error parameter θ 220 may include computing a value of the at least one target error parameter θ, by fitting a model to the set of measurement values 247.

In some embodiments, the at least one characterization sequence S 213 may be configured for reducing predefined coherent error generator terms P_{b} in the targeted set of qubits 233. In other words, the at least one refocusing sequence R 217 may be configured so predefined terms P_{b} (e.g., Pauli terms) of H_{ce} may have an effective value less than the bare value.

In some embodiments, the at least one target error parameter θ may be a Pauli generator term Pₜ 231. That is, expanding Hₑᵣᵣ as a sum of Pauli terms (see expansion 160 in FIG. 1), the error parameter may be a coefficient cₜ corresponding a Pauli term Pₜ of Hₑᵣᵣ. The Pauli generator term Pₜ 231 may be any Pauli term of Hₑᵣᵣ, i.e., the Pauli generator term Pₜ 231 may be a Pauli term of the coherent error generator H_{ce}, may be a Pauli term of the dissipative error generator L_{dis}, or may be a Pauli term of the crosstalk error generator Hᵢₙₜ.

In some embodiments, the at least one characterization sequence S 213 may be configured for increasing a magnitude measure of the crosstalk. This may be desired, for example, in order to characterize crosstalk. In some other embodiments, the at least one characterization sequence S 213 may be configured to reduce a magnitude measure of said crosstalk. This may be desired, for example, in order to characterize coherent errors or dissipative errors. The magnitude measure may be defined by a measured quantity, for example, a frequency of Rabi oscillation, or a correlation coefficient of correlation between qubits. It is noted that a magnitude measure of the crosstalk can be reduced, while at the same time some terms of the crosstalk may be amplified.

In some embodiments, the at least one characterization sequence S 213 may be configured to eliminate at least a first-order error of implementation errors distinct from the at least one target error parameter θ 237. That is, the error generator Hₑᵣᵣ may be expanded as a Dyson-series (or as a Magnus-expansion) according to the scale-parameter ε. The linear term in the Dyson-series of the error generator Hₑᵣᵣ may be denoted H₁. A zeroth term of the Dyson-series is equal to Hₛₑₜ and therefore can be ignored (not included in the expansion). An effective value of H₁ may only include terms that are related to the at least one target error parameter θ. These terms may be equal to H_{err,bare}^{θ}. For example, the at least one target error parameter θ may be a Pauli term Pₜ. Coefficients of Pauli terms P_{b} in the effective value of H₁, that are distinct from Pₜ, may be zero. An effective value of P_{b}+Pₜ may scale as O(εⁿ) with n≥2. Higher order term cancelation for n>2 can be achieved, for example, using higher order DD concatenation.

It is noted that when a first-order error of implementation errors is eliminated 237, the linear term in H_{eff} may be multiplied by a transfer function. The transfer function may be a function that maps the implementation errors from “during-errors” to “after-errors”. That is, a function that maps representation of errors from occurring during the application of the quantum logic operation g, to occurring after the application of the quantum logic operation g.

In some embodiments, the at least one characterization sequence S 213 may include q germs (see hereinbelow for elaboration). An effective value of Pₜ may be εqN_{g}×H_{err,bare}^{θ}, i.e., the coefficient cₜ may be εqN_{g}×H_{err,bare}^{θ}, where N_{g} is the number of gates g in a germ.

In some embodiments, terms of order higher than the first, in the perturbative expansion of Hₑᵣᵣ may be reduced. That is, an effective value of at least one Hₙ, where n>1, may be reduced compared to a bare value of the at least one Hₙ. For example, an effective value of H₂ (the term quadratic in ¿) may be reduced compared to a bare value of H₂. In some embodiments, an effective value of the at least one Hₙ may only include terms are related to the at least one target error parameter θ.

In some embodiments, the at least one characterization sequence S may be configured to eliminate predefined Pauli generator terms of the implementation errors distinct from the at least one target error parameter. In other words, the effective value of the predefined Pauli generator terms may be less than a predefined threshold. Therefore, the effective value of the predefined Pauli generator terms of the implementation errors may be equivalent to zero. For example, a first-order error may vanish.

In some embodiments, the at least error parameter θ may include a plurality of targeted error parameters. For example, a plurality of Pauli terms Pₜ⁽ⁱ⁾. In other embodiments, the at least one target error parameter θ may consist of a single error parameter. In other words, method may characterize a single target error parameter of implementation errors in the quantum logic operation g.

In some embodiments, the method 200 may include recompiling the at least one characterization sequence S 213. The recompiling may include replacing adjacent quantum operations (i.e., quantum operations that should be run immediately one after the other) by equivalent quantum operations. The recompiling may be performed in order to enhance a performance of the at least one characterization sequence S 213. The performance of the at least one characterization sequence S 213 may be enhanced, for example, by not using quantum operations having large implementation errors.

In some embodiments, the method may be repeated in order to characterize all error parameters of the quantum logic operation g. In other words, the method may be repeated in order to completely characterize the quantum logic operation g.

The method 200 may be performed in parallel. That is, the method 200 may be applied to at least two quantum logic operations in parallel. In some embodiments, the method 200 may be applied to a gate layer. That is, the quantum logic operation g 215 may be a gate layer. In some embodiments, the at least one refocusing sequence R 217 may include at least one gate layer.

The method 200 may be used to characterize quantum processors. A quantum processor may include a plurality of quantum logic operations. A method for characterizing the quantum processor may include applying the method 200 to at least one quantum logic operation that may be included in the plurality of quantum logic operations of the quantum processor.

The method 200 may be applicable to quantum processors that may include qudits, i.e., quantum systems where the number of states that may be measured, may include more than two states. Mathematically, a qudit may be described by a state vector [symbol] ⁿ where n>2. In some embodiments, the different states of the qudits of the quantum processor may be mapped to equivalent states of qubits. For example, referring to FIG. 1, the qubits Q1 through Q6 may be replaced by qutrits, i.e., qudits that may have three states that may be measured. A state vector of the quantum processor 100 may then include 81 states. These 81 states may be mapped to 81 states of a virtual quantum processor that may include 7 qubits. 47 states of the virtual quantum processor may be unused. That is, the entries of the state-vector, representing these 47 states may be set to zero throughout any computation. In a different example, the qubits Q1 through Q6 may be replaced by systems qudits that may have four states that may be measured. A state vector of the quantum processor 100 may then include 4096 states. The state vector may be mapped to a virtual quantum processor that may include 12 qubits, where no state of the virtual quantum processor may be unused. In some embodiments, Pauli matrices may be replaced by generators of the SU(n) group.

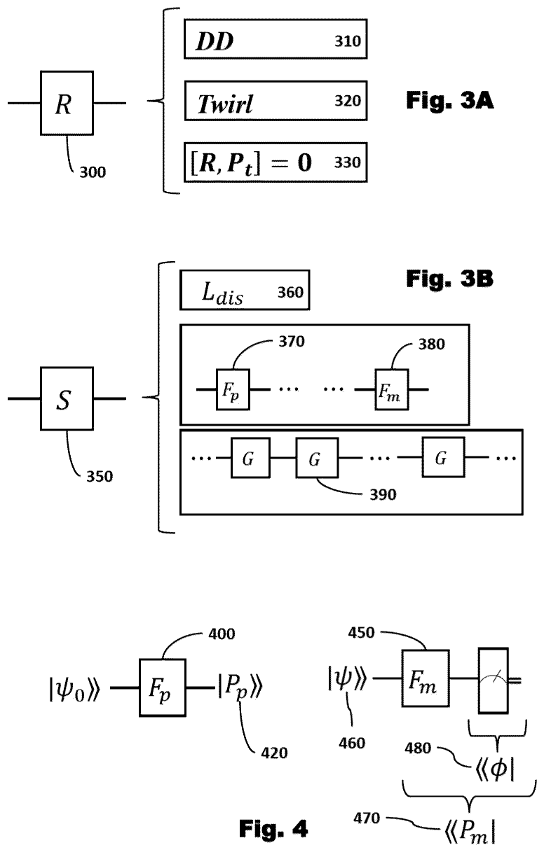

FIG. 3A schematically illustrates features of the at least one refocusing sequence, according to embodiments of the present disclosure. In some embodiments, the at least one refocusing sequence 300 may be a dynamical decoupling sequence 310. In other words, the at least one refocusing sequence 300 may include at least one dynamical decoupling sequence 310. In some embodiments, the at least one refocusing sequence 300 may be a twirling sequence 320. In other words, the at least one refocusing sequence 300 may include at least one twirling sequence 320. In some embodiments, the at least one refocusing sequence 300 may include both dynamical decoupling sequences 310 and twirling sequences 320. Further features of twirling sequences 320, according to embodiments of the present disclosure, may be described hereinbelow in relation to FIG. 8. In some embodiments, the at least one target error parameter θ may be a Pauli generator term Pₜ. The at least one refocusing sequence 300 may commute with said Pauli generator term Pₜ 330.

FIG. 3B schematically illustrates features of the at least one characterization sequence, according to embodiments of the present disclosure. In some embodiments, the at least one characterization sequence S 350 may be configured for characterizing dissipation implementation errors. In other words, the at least one characterization sequence S 350 may be configured to characterize L_{dis}. The dissipation implementation errors may be Markovian and/or non-Markovian. In other words, in some embodiments, L_{dis} may depend only on the quantum logic operation g. In other embodiments, L_{dis} may also depend on any other parameter, such as a power spectrum of the noise (i.e., power spectrum of fluctuations), on other gates that may have been applied, on gates that may be applied in parallel to the quantum logic operation g. The refocusing sequences may keep the fluctuations in the Pₜ parameter. That is, the refocusing sequences may reduce the fluctuations in other parameters.

In some embodiments, the at least one characterization sequence S 350 may include at least one fiducial operation. The at least one fiducial operation may include a preparation fiducial operation 370. The preparation fiducial operation 370 may set a state of the targeted set of qubits to a predefined state. For example, the preparation fiducial operation 370 may be applied after a reset operation or after a measurement operation. The at least one fiducial operation may include a measurement fiducial operation 380. The measurement fiducial operation 380 may change a state of the targeted set of qubits before a measurement of the targeted set of qubits. The measurement fiducial operation 380 may be applied in order to measure the targeted set of qubits in a predefined base. For example, a measurement apparatus of the quantum processor may support measurement of qubits in only the Z basis. A measurement of the targeted set of qubits in the X basis may be needed. The measurement fiducial operation 380 may rotate the state of the targeted set of qubits, so a measurement according to the Z basis, of the rotated state, may correspond to a measurement according to the X basis, of the unrotated state.

In some embodiments, the least one fiducial operation may include at least one gate layer.

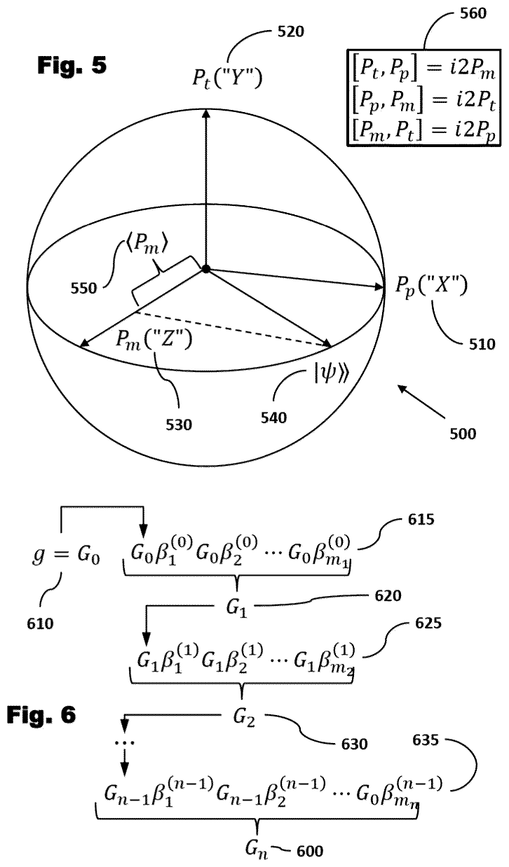

Further features of fiducial operations, according to embodiments of the present disclosure, may be described hereinbelow in relation to FIGS. 4-5.

In some embodiments, the at least one characterization sequence S 350 may include at least one germ 390. The at least one germ 390 may be a quantum operation or a sequence of quantum operations (e.g., a subcircuit). The at least one germ 390 may be configured to be sensitive to the at least one target error parameter θ.

In some embodiments, the at least one characterization sequence S 350 may include a plurality of characterization sequences, that may have a varying number of germs. In other words, the plurality of characterization sequences may include at least a first characterization sequence and a second first characterization sequence. The number of germs included in the first characterization sequence may be different than the number of germs included in the second characterization sequence. In some embodiments, the number of germs may be logarithmically spaced. In other words, the number of germs, in each characterization sequence included in the plurality of characterization sequences, may be equal to integer powers of an integer number. For example, the number of germs may be powers of two (1, 2, 4, 8, . . . ). In some embodiments, the number of germs may be powers of a fractional number ƒᵣ>1, rounded to the nearby integer. For example: ƒᵣ=1.4, and the number of germs may be int (ƒᵣⁿ)=[1, 2, 3, 5, 7, 10, 14, 20, 28, 40, . . . ].

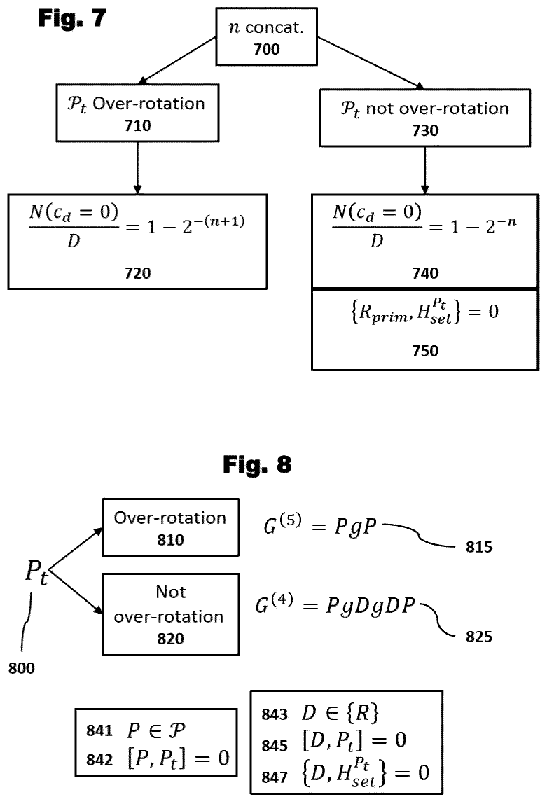

Further features of germs, according to embodiments of the present disclosure, may be described hereinbelow in relation to FIGS. 6-7.

FIG. 4 illustrates properties of fiducial operations according to embodiments of the present disclosure. In some embodiments, the at least one fiducial operation may include state preparation operations 400 configured for setting a state of the set of qubits to a preparation Pauli state Pₚ 420. That is, the state preparation operations 400 may set the state of the set of qubits to a state that may be represented by a Pauli matrix. The at least one fiducial operation may include measuring the set of qubits according to a measurement Pauli Pₘ 470. That is, measuring a coefficient of a Pauli term of the state of the set of qubits 460. Measuring the set of qubits according to a measurement Pauli Pₘ 470 may include applying a measurement fiducial operation 450 and measuring the set of qubits according to a natively available measurement operation 480. Measuring the qubits 480 after applying the measurement fiducial operation 450 may be equivalent to measuring a coefficient of a Pauli term of the state of the set of qubits 460.

In some embodiments, measuring the set of qubits according to a measurement Pauli Pₘ 470 may be natively supported by the quantum processor. The measurement fiducial operation 450 may be omitted.

FIG. 5 illustrates further properties of fiducial operations according to embodiments of the present disclosure. In some embodiments, the preparation Pauli state Pₚ, the measurement Pauli Pₘ, and the Pauli generator term Pₜ, may span an algebra isomorphic to the SU(2) Lie algebra. That is, the preparation Pauli state Pₚ, measurement Pauli Pₘ, and the Pauli generator term Pₜ, may have commutation relations 560 that constitute an SU(2) Lie algebra. That is, for example, the commutator of the Pauli generator term Pₜ and the preparation Pauli state Pₚ may equal the measurement Pauli Pₘ, up to a π/2 phase. The preparation Pauli state Pₚ, measurement Pauli Pₘ, and the Pauli generator term Pₜ, may each correspond an axis of a Bloch sphere 500. The preparation Pauli state Pₚ 510 may correspond the X axis of the Bloch sphere 500. The measurement Pauli Pₘ 520 may correspond the Z axis of the Bloch sphere 500. The Pauli generator term Pₜ 530 may correspond the Y axis of the Bloch sphere 500. The measurement according to the measurement Pauli Pₘ may correspond to a projection 550 of a state of the set of qubits 540 on the measurement Pauli Pₘ axis (Z axis) of the Bloch sphere 500.

In some embodiments, the preparation Pauli state Pₚ and measurement Pauli Pₘ may be configured for increasing a sensitivity of the least one characterization sequence S to the at least one error parameter θ.

In some embodiments, where the at least one characterization sequence S may include at least one germ, the at least one germ may be a recursively concatenated germ.

FIG. 6 illustrates a recursively concatenated germ 600. Conceptually, the recursively concatenated germ 600 may be built by concatenating intermediate germs, themselves defined as recursively concatenated germs. In some embodiments, the at least one refocusing sequence may include a set of refocusing sequences. The at least one characterization sequence S may include a recursively concatenated germ. The recursively concatenated germ may be obtained by computing a predefined number n of concatenations Gₖ₊₁=ΠₘGₖβₘ^{(k)}, wherein k=0, 1, . . . , n−1. The βₘ^{(k)} may be refocusing sequences included in the set of refocusing sequences. G₀=g, where g may be the quantum logic operation (i.e., the quantum logic operation that may be characterized).

In more detail, the quantum logic operation g may define an end case, or a recursion base G₀ 610. A first subsequence 615 may include m₁ instances of G₀. The first subsequence 615 may include refocusing sequences βᵢ⁽⁰⁾ after each instance of G₀. The first subsequence 615 may be denoted G₁ 620.

A second subsequence 625 may include m₂ instances of G₁. The first subsequence 625 may include refocusing sequences βᵢ⁽¹⁾ after each instance of G₁. The second subsequence 625 may be denoted G₂ 630.

A third subsequence, fourth subsequence, and further subsequences may be obtained in a similar way. The recursively concatenated germ 600 may be the n'th subsequence 635. The recursively concatenated germ 600 may be denoted by Gₙ.

Each concatenation, where a preceding subsequence Gₖ₋₁ is concatenated to obtain a subsequence Gₖ may be referred to as a concatenation step. Therefore, n concatenation steps may be performed in order to obtain the recursively concatenated germ 600. In other words, the recursively concatenated germ 600 may have n concatenation steps.

Generally, any subsequence Gₖ may not be restricted to include only the preceding subsequence Gₖ₋₁ and refocusing sequences. In other words, any of the refocusing sequences βᵢ^{(j)} may be replaced by any quantum operation.

Generally, any subsequence Gₖ may not be restricted to include only one quantum operation after each instance of the preceding subsequence Gₖ₋₁. In other words, any of the refocusing sequences βᵢ^{(j)} may be replaced by multiple quantum operations. In some embodiments, any subsequence Gₖ may include quantum operations before the first instance of Gₖ₋₁. For example, the first subsequence 615 may be G₁=β₀⁽⁰⁾G₀β₁⁽⁰⁾G₀β₂⁽⁰⁾ . . . G₀βₘ_{₁}⁽⁰⁾.

In some embodiments, at least one of the β; may be omitted. In other words, in any subsequence Gₖ, at least two instances of the preceding subsequence Gₖ₋₁ may have no quantum operation between them. In yet other words, any subsequence Gₖ, may include powers of the preceding subsequence (Gₖ₋₁)^{N}, where N>1. For example, the second subsequence 625 may be G₂=G₁β₁⁽¹⁾G₁β₂⁽¹⁾ . . . (G₁)^{N}β_{q}⁽¹⁾ . . . . G₁βₘ_{₂}⁽¹⁾.

Generally, the recursively concatenated germ 600 may be obtained in an iterative process instead of a recursive process. In other words, no routine that may be included in an algorithm, used to obtain the recursively concatenated germ 600, may need to call itself as a subroutine. In some embodiments, a combination of an iterative process and a recursive process may be used in an algorithm for obtaining the recursively concatenated germ 600. FIG. 7 illustrates properties of recursively concatenated germs. A recursively concatenated germ may be configured to eliminate a predefined number of Pauli terms of implementation errors. In other words, the recursively concatenated germ may be configured to zero (i.e., reduce below a predefined threshold) a predefined number of coefficients c_{d} of Pauli terms of an effective value of Hₑᵣᵣ. The predefined number of eliminated Pauli terms may depend on the number of concatenation steps n and on the type of the at least one error parameter θ.

The at least one error parameter θ may be a Pauli generator term Pₜ. The Pauli generator term Pₜ may be an over-rotation term 710. That is, the Pauli generator term Pₜ may relate to a deviation of a rotation angle from a rotation angle that the quantum logic operation g may be configured to perform. The recursively concatenated germ may comprise at least n concatenation steps 700. The at least one characterization sequence S may be configured to eliminate a fraction of 1-2⁻⁽ⁿ⁺¹⁾ of Pauli generator terms of the implementation errors 720. In other words, the number of coefficients c_{d} that may be zero, divided by D (the number of Pauli terms in the expansion of Hₑᵣᵣ), may equal 1-2-(n+1). For example, for a single concatenation step, three quarters of the coefficients c_{d} may be set to zero. For two concatenation steps, seven eighths of the coefficients c_{d} may be set to zero. The coefficients c_{d} that may be zero, may be distinct from the coefficient cₜ that may correspond the Pauli generator term Pₜ.

The at least one error parameter θ may be a Pauli generator term Pₜ. The Pauli generator term Pₜ may be distinct from an over-rotation term 730. The recursively concatenated germ may have at least n concatenation steps 700. The at least one characterization sequence S may be configured to eliminate a fraction of 1-2⁻ⁿ of Pauli generator terms of the implementation errors 740. In other words, the number of coefficients c_{d} that may be zero, divided by D (the number of Pauli terms in the expansion of Hₑᵣᵣ), may equal 1-2⁻ⁿ. For example, for a single concatenation step, half of the coefficients c_{d} may be set to zero. For two concatenation steps, three quarters of the coefficients c_{d} may be set to zero. The coefficients c_{d} that may be zero, may be distinct from the coefficient cₜ that may correspond the Pauli generator term Pₜ.

In some embodiments, the at least one characterization sequence S may be configured to isolate the Pauli generator term Pₜ of the implementation errors. In other words, only the coefficient cₜ, that may correspond Pₜ in expansion of the effective value Hₑᵣᵣ (according to Pauli matrices), may not be zero. For example, the quantum logic operation g may be a two-qubit gate, therefore, there may be 16 Pauli terms in the expansion of Hₑᵣᵣ. The Pauli generator term Pₜ may be distinct from an over-rotation term 730, and there may be at least four concatenation steps. In a different example, the Pauli generator term Pₜ may be an over-rotation term 720, and there may beat least three concatenation steps.

The fraction of eliminated Pauli generator terms may depend on the choice of the refocusing sequences that may be included in the recursively concatenated germ, and may depend on how each refocusing sequence may be included. In other words, using the notation used in relation to FIG. 6, what may the exact βᵢ^{(j)} be. One refocusing sequence, that may eliminate a half of the Pauli generator terms, may be referred to as a “primary refocusing sequence”. A refocusing sequence other than the primary refocusing sequence may be referred to as a “secondary refocusing sequence”. The choice of secondary refocusing sequences may be permutation-invariant. That is, a recursively concatenated germ may include secondary refocusing sequences that may be included in a set of refocusing sequences {β}. Swapping of any secondary refocusing sequence Bi by any secondary refocusing sequence βⱼ, where i≠j, may have no effect on the recursively concatenated germ.

In some embodiments, the Pauli generator term Pₜ may be distinct from an over-rotation term. The at least one refocusing sequence may include a primary refocusing sequence Rₚᵣᵢₘ. The primary refocusing sequence may anti-commute with a corresponding Pauli generator term Hₛₑₜ^{P}^{ₜ} of an ideal version of said quantum logic operation g (that is, g_{ideal}) 750.

Examples of recursively concatenated germs, that may be included in the at least one characterization sequence S are given hereinbelow. In contrast to the description relating to FIG. 6, the notation used for these exemplary recursively concatenated germs may not indicate a number of concatenation steps. That is, Gₙ may not necessarily have n concatenation steps.

The Pauli generator term Pₜ may be an over-rotation term. In some embodiments, the at least one characterization sequence S may include at least one of the germs G₀⁽¹⁾=gA, and G₁⁽¹⁾=BG₀⁽¹⁾CG₀⁽¹⁾, where A, B, C may be refocusing sequences. In some embodiments, the at least one characterization sequence S may include at least one of the germs G₀⁽²⁾=gAgA, and G₁⁽²⁾=BG₀⁽²⁾CG₀⁽²⁾, where A, B, C may be refocusing sequences.

The Pauli generator term Pₜ may be distinct from an over-rotation term. In some embodiments, the at least one characterization sequence S may include at least one of the germs G₀⁽³⁾=gAgA, G₁⁽³⁾=G₀⁽³⁾AG₀⁽³⁾A, G₂⁽³⁾=BG₁⁽³⁾CG₁⁽³⁾, and G₂⁽³⁾=G₁⁽³⁾BG₁⁽³⁾C, wherein A, B, C may be refocusing sequences.

As indicated hereinabove, in the description relating to FIG. 3A, the at least one refocusing sequence may include at least one twirling sequence. The at least one twirling sequence may include randomly sampled quantum operations. In other words, the at least one characterization sequence S may include randomly sampled quantum operations. In some embodiments, the random sampling may include randomly sampling refocusing sequences. In some embodiments, the at least one characterization sequence S may include refocusing sequences randomly sampled for each application of the at least one characterization sequence S.

FIG. 8 illustrates features and examples of twirling subsequences, that may be included in characterization sequences, according to embodiments of the present disclosure.

The at least one error parameter θ may be a Pauli generator term Pₜ 800. The Pauli generator term Pₜ 800 may be an over-rotation Pauli term 810. The at least one characterization sequence S may include at least one subsequence G⁽⁵⁾=PgP 815. P may be a randomly sampled Pauli operator 841. P may commute with the Pauli generator term Pₜ 842.

The at least one error parameter θ may be a Pauli generator term Pₜ 800. The Pauli generator term Pₜ 800 may be distinct from an over-rotation Pauli term 820. The at least one characterization sequence S may include at least one subsequence G⁽⁴⁾=PgDgDP 825. P may be a randomly sampled Pauli operator 841. D may be a refocusing sequence 843. D may commute with the Pauli generator term Pₜ 845. D may anti-commute with a corresponding Pauli generator term Het, of an ideal version of said quantum logic operation g 847. In some embodiments, D may be randomly sampled.

Some embodiments that may use twirling subsequences, may include averaging over characterization sequences. In other words, a plurality of characterization sequences may be applied to the targeted set of qubits. The qubits may be measured after each application of a characterization sequence. The results of the measurements may be averaged.

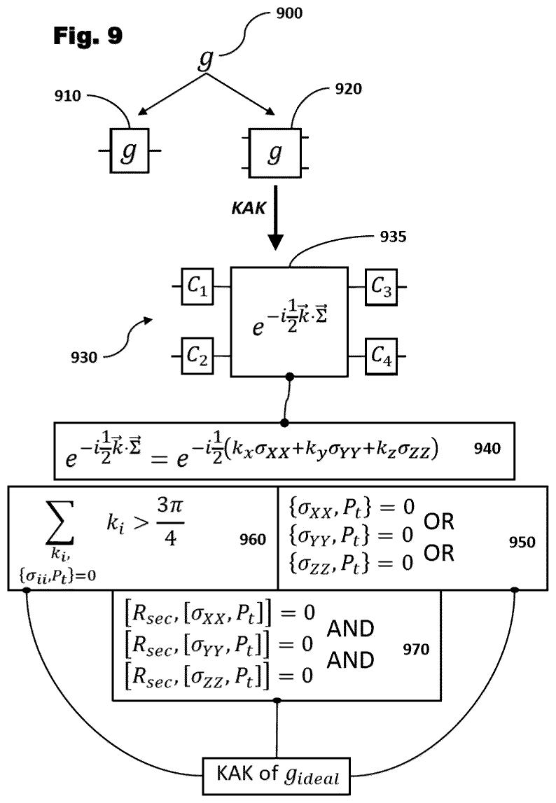

FIG. 9 illustrates properties of quantum logic operations and refocusing sequences according to embodiments of the present disclosure. In some embodiments, the quantum logic operation g 900 may be a single-qubit operation 910. In some other embodiments, the quantum logic operation g 900 may be a two-qubit operation 920. A KAK decomposition 930 of the quantum logic operation g 900 may include any of one generator, two generators, and three generators.

The KAK decomposition 930 is as follows. Any two-qubit operation may be equivalent to a two-qubit operation of a type

$${e}^{- \frac{i}{2} \vec{k} \cdot \vec{Σ}}$$

935, preceded by two single-qubit equivalent to a two-qubit operation of a type operations C₁, C₂, and succeeded two single-qubit operations C₃, C₄. Any of the single qubit operations C₁ to C₄ can be an identity operation. The vector \vec{k} represents three real-valued parameters kₓ, k_{y}, k_{z}. The vector 2 represents the three operators σ_{XX}, σ_{YY}, σ_{ZZ}. Therefore, the operation of a type

$${e}^{- \frac{i}{2} \vec{k} \cdot \vec{Σ}}$$

935 is a two-qubit operation with a generator that is a the operation of a type weighted-sum of the operators represented by \vec{Σ}, with weights given by \vec{k} 940. If the vector \vec{k} includes only non-zero elements, the KAK decomposition may be described as having three generators. If the vector \vec{k} includes one or two non-zero elements, the KAK decomposition may be described as having one generator or having two generators, respectively.

It is noted that with a change of basis of the qubits, the generators represented by \vec{Σ} may be permuted, or may be changed to any of the operators σ_{XY}, σ_{XZ}, σ_{YX}, σ_{YZ}, σ_{ZX}, σ_{ZY}. For example, rotating the basis of the second qubit, the generators σ_{XX}, σ_{YY}, σ_{ZZ} may change to σ_{XY}, σ_{YZ}, σ_{ZX}.

The significance of the KAK decomposition is that single-qubit operations may have implementation-errors that are negligible in comparison to implementation errors of two-qubit operations. Therefore, in some embodiments, a characterization of the two-qubit quantum logic operation g 920 may be achieved by characterizing a corresponding operation of a type

$${e}^{- \frac{i}{2} \vec{k} \cdot \vec{Σ}}$$

935. Characterizing the corresponding operation of a type

$${e}^{- \frac{i}{2} \vec{k} \cdot \vec{Σ}}$$

935 may have the benefit of simpler characterization procedure, least for having a simpler structure. In some embodiments, characterizing the corresponding operation of a type

$${e}^{- \frac{i}{2} \vec{k} \cdot \vec{Σ}}$$

935 may include replacing at least one instance of the quantum logic operation g 900 by (C₁^{†}⊗C₂^{†})g(C₃^{†}⊗C₄^{†}).

In some embodiments, the quantum logic operation g 900 may be a two-qubit operation 920. The at least one target error parameter θ may be a Pauli generator term Pₜ. An ideal version of said quantum logic operation g may have a KAK decomposition having coefficients kₓ, k_{y}, k_{z}. The Pauli generator term Pₜ may anti-commute with at least one generator of the KAK decomposition of the ideal version of said quantum logic operation g 950. A sum of coefficients may greater than

$$\frac{3 π}{4} ,$$

where the coefficients may correspond to the at least one KAK generator anti-commuting with the Pauli generator term Pₜ. In other words, the sum of coefficients, that correspond the generators that anti-commute with the Pauli generator term Pₜ, may be greater than

$$\frac{3 π}{4}$$

960. The at least one refocusing sequence comprises at least one secondary refocusing sequence R_{sec}. The at least one secondary refocusing sequence R_{sec} may commute with all commutators of the Pauli generator term Pₜ and generators of said KAK decomposition of an ideal version of said quantum logic operation g 970.

It is noted that if any of the coefficients kₓ, k_{y}, k_{z} is zero, the corresponding KAK generator may be omitted from the anti-commutation conditions 950 and the commutation conditions 960. That is, for example, if the coefficient k_{z} is zero, the anti-commutation conditions 950 may require that {σ_{XX}, Pₜ}=0 or {σ_{YY}, Pₜ}=0. Whether the condition {σ_{ZZ}, Pₜ}=0 is met, may be irrelevant. The commutation conditions 960 may require that [R_{sec}, [σ_{XX}, Pₜ]]=0 and [R_{sec}, [σ_{YY}, Pₜ]]=0. Whether the condition [R_{sec}, [σ_{ZZ}, Pₜ]]=0 is met, may be irrelevant.

It is noted that single-qubit gates may have a “degenerate KAK decomposition”. The single qubit operations C₁ to C₄ may all be identity operations. The generators may be σ_{XI}, σ_{YI}, σ_{ZI}. Because the generators do not affect the second qubit, the single-qubit rotation about the \vec{k} axis operator is obtained.

As indicated hereinabove in the description relating to FIG. 2, methods according to the present disclosure may be applied in parallel for multiple quantum logic operations (i.e., at least two quantum logic operations). In some embodiments, the qubits may be partitioned. That is, the qubits may be divided into qubit-sets. The qubit-sets may each include qubit-subsets that may have characterization sequences applied to them simultaneously. In other words, subsets of a single qubit-set may include qubits, that quantum logic operations that may be applied to them, may be characterized in parallel. Qubit-subsets can include only a single qubit.

The partition may depend on the quantum logic operations that may be characterized, may depend on the target error parameters that may be selected, may depend on the characterization sequences and refocusing sequences that may be used, and may depend on characteristics of the quantum processor.

The partition may be described by hypergraphs. A qubit-subset may correspond to an edge of a hypergraph. The plurality of qubit-subsets may together form a complete hypergraph. Hyperedges can overlap, i.e., a qubit may be included in two hyperedges of the hypergraph.

In some embodiments, an edge of a hypergraph may include qubits that may have crosstalk between them. The hypergraph may then be referred to as “interaction hypergraph”. In some embodiments, the at least two quantum logic operations may operate on corresponding subsets of qubits (i.e., qubit-subsets). Each of the corresponding subsets of qubits may have no common qubit. That is, for each pair of subsets of qubits, no qubit may be common to the subsets of qubits. In some embodiments, no crosstalk may be present between each of the corresponding subsets of qubits. In the language of hypergraphs, each of the corresponding subsets of qubits may be included in a corresponding hyperedge of an interaction hypergraph. Each of the corresponding hyperedges may be unique (i.e., may have no overlap) for each of the corresponding subsets of qubits. The process of partitioning may be referred to as “coloring of a hypergraph”.

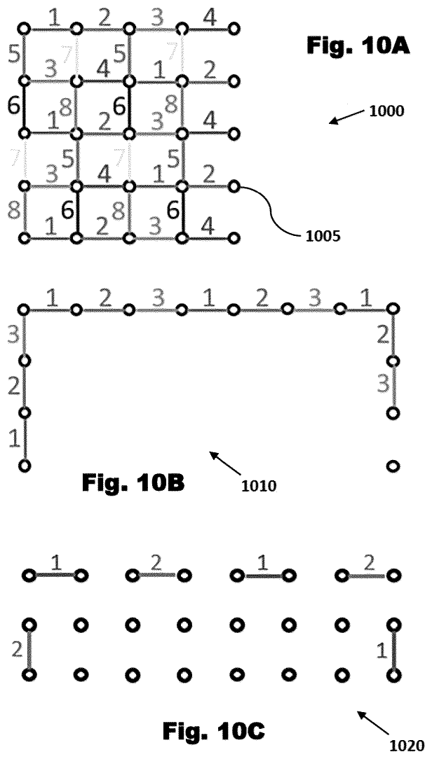

FIGS. 10A-10C illustrate exemplary partitions of qubits according to embodiments of the present disclosure. FIG. 10A illustrates a quantum processor 1000 that may have a plurality of qubits, such as qubit 1005. The plurality of qubits may be physically positioned so as to form a square lattice. The qubits may have crosstalk. The crosstalk may be modelled by a nearest-neighbor model between pairs of qubits. An interaction hypergraph may be equivalent to a regular graph. An edge may connect a pair of qubits having crosstalk between them.

A characterization method, according to embodiments of this disclosure, may be applied in order to characterize quantum logic operations of the quantum processor 1000. The quantum logic operations may be two-qubit operations. The quantum logic operations may be applied to any pair of qubits that are nearest neighbors. Each quantum logic operation may operate on a corresponding qubit-subset of two qubits. A corresponding qubit-subset of two qubits may correspond an edge of the graph (hyperedge of the interaction hypergraph). The at least one target error parameter may be Pauli generator terms of crosstalk (Hᵢₙₜ), between qubits included in the corresponding qubit-subset, and qubits not included in the corresponding qubit-subset.

The refocusing sequences may consist of dynamical decoupling sequences. Each of the corresponding qubit-subsets may have no common qubit. No crosstalk may be present between each of the corresponding qubit-subsets. In other words, each corresponding qubit-subset may be separated by at least one qubit.

The plurality of qubits may be partitioned into 8 qubit-sets. Therefore, characterizing all the quantum logic operations may require applying the characterizing method eight times, each time to a different qubit-set. That is, in each time, the method may be applied, in parallel, to quantum logic operations that may correspond qubit-subsets that may be included in a single qubit-set.

The qubit-sets may be numbered from 1 to 8. Each qubit-subset (graph edges) is labeled according to the qubit-set that may include it.

FIG. 10B illustrates a quantum processor 1010. The settings of the quantum processor 1010 may be similar to the settings of the quantum processor 1000 illustrated in FIG. 10A. A difference between the quantum processor 1000 and the quantum processor 1010 may be that in the quantum processor 1010, the qubits may be positioned so as to form a one-dimensional chain. The characterization method applied to the quantum processor 1010 may be similar to the method applied to the quantum processor 1000.

The plurality of qubits may be partitioned into 3 qubit-sets. The qubit-sets may be numbered from 1 to 3. Each qubit-subset (graph edges) is labeled according to the qubit-set that may include it.

FIG. 10C illustrates a quantum processor 1020. The settings of the quantum processor 1020 may be similar to the settings of the quantum processor 1000 illustrated in FIG. 10A. The characterization method applied to the quantum processor 1020 may be similar to the method applied to the quantum processor 1000. A difference between the characterization method applied to the quantum processor 1000, and the characterization method applied to the quantum processor 1020, may be that in the characterization method applied to the quantum processor 1020, the at least one target error parameter may be Pauli generator terms of an error generator that may act inside each of the qubit-subsets. That is, the at least one target error parameter may be Pauli generator terms of H_{ce} or L_{dis} of each of the qubit-subsets. Another difference is that the method may be applied to select qubits of the quantum processor 1020. The select qubits may form a one-dimensional chain.

It is noted that the partitioning of the qubits in the quantum processor 1020 may be different from the partitioning of the qubits in the quantum processor 1010. In the quantum processor 1020, crosstalk can be present between each of the corresponding qubit-subsets. This is in contrast to the quantum processor 1010 where, as indicated hereinabove, crosstalk may not be present between each of the corresponding qubit-subsets. The difference in the partition may be caused by the different at least one target error parameter.

The plurality of qubits may be partitioned into 2 qubit-sets. The qubit-sets may be numbered from 1 to 2. Each qubit-subset (graph edges) is labeled according to the qubit-set that may include it.

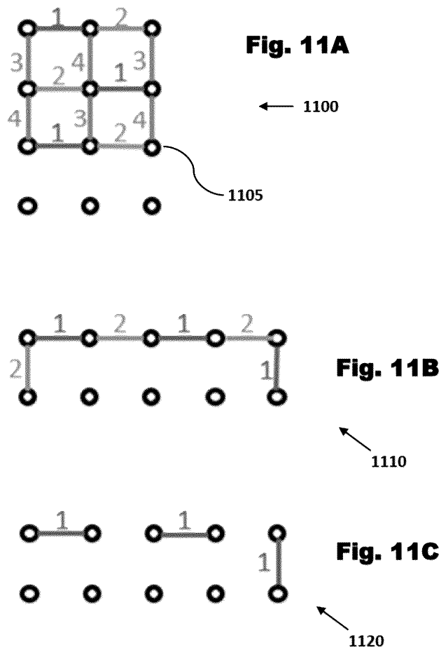

FIG. 11A-11C illustrate partitions of qubits according to other embodiments of the present disclosure. FIG. 11A illustrates a quantum processor 1100 that may have a plurality of qubits, such as qubit 1105. The plurality of qubits may be physically positioned so as to form a square lattice. The qubits may have crosstalk. The crosstalk may be modelled by a nearest-neighbor model between pairs of qubits. An interaction hypergraph may be equivalent to a regular graph. An edge may connect a pair of qubits having crosstalk between them.

A characterization method, according to embodiments of this disclosure, may be applied in order to characterize quantum logic operations of the quantum processor 1100. The quantum logic operations may be two-qubit operations. The quantum logic operations may be applied to any pair of qubits that are nearest neighbors. Each quantum logic operation may operate on a corresponding qubit-subset of two qubits. A corresponding qubit-subset of two qubits may correspond an edge of the graph (hyperedge of the interaction hypergraph). The at least one target error parameter may be Pauli generator terms of crosstalk (Hᵢₙₜ), between qubits included in the corresponding qubit-subset, and qubits not included in the corresponding qubit-subset.

The refocusing sequences may consist of twirling sequences. Each of the corresponding qubit-subsets may have no common qubit.

The plurality of qubits may be partitioned into 4 qubit-sets. Therefore, characterizing all the quantum logic operations may require applying the characterizing method four times, each time to a different qubit-set. That is, in each time, the method may be applied, in parallel, to quantum logic operations that may correspond qubit-subsets that may be included in a single qubit-set.

The qubit-sets may be numbered from 1 to 4. Each qubit-subset (graph edges) is labeled according to the qubit-set that may include it.

FIG. 11B illustrates a quantum processor 1110. The settings of the quantum processor 1110 may be similar to the settings of the quantum processor 1100 illustrated in FIG. 11A. The characterization method applied to the quantum processor 1110 may be similar to the method applied to the quantum processor 1100. A difference between the characterization method applied to the quantum processor 1100, and the characterization method applied to the quantum processor 1110, may be that the method may be applied to select qubits of the quantum processor 1110. The select qubits may form a one-dimensional chain.

The plurality of qubits may be partitioned into 2 qubit-sets. The qubit-sets may be numbered from 1 to 2. Each qubit-subset (graph edges) is labeled according to the qubit-set that may include it.

FIG. 11C illustrates a quantum processor 1120. The settings of the quantum processor 1120 may be similar to the settings of the quantum processor 1100 illustrated in FIG. 10A. The characterization method applied to the quantum processor 1120 may be similar to the method applied to the quantum processor 1100. A difference between the characterization method applied to the quantum processor 1100, and the characterization method applied to the quantum processor 1120, may be that in the characterization method applied to the quantum processor 1120, the at least one target error parameter may be Pauli generator terms of an error generator that may act inside each of the qubit-subsets. That is, the at least one target error parameter may be Pauli generator terms of H_{ce} or L_{dis} of each of the qubit-subsets. Another difference is that the method may be applied to select qubits of the quantum processor 1120. The select qubits may form a one-dimensional chain.

The plurality of (select) qubits may be partitioned into a single qubit-set. Each qubit-subset (graph edges) is labeled by the digit 1.

Generally, characterization sequences that may include twirling sequences, may require that each of the corresponding qubit-subsets may have no common qubit. Crosstalk can be present between each of the corresponding qubit-subsets.

Generally, characterization sequences that may include dynamical decoupling sequences, may require that each of the corresponding qubit-subsets may have no common qubit. For characterization of crosstalk, it may further be required that no crosstalk may be present between each of the corresponding qubit-subsets.

Generally, characterization sequences that may include dynamical decoupling sequences may be applied in parallel to characterization sequences that may include twirling sequences. The partitioning may then include, in at least one qubit-set, qubit-subsets that may have crosstalk between them, and qubit-subsets that may have no crosstalk presenting between them.

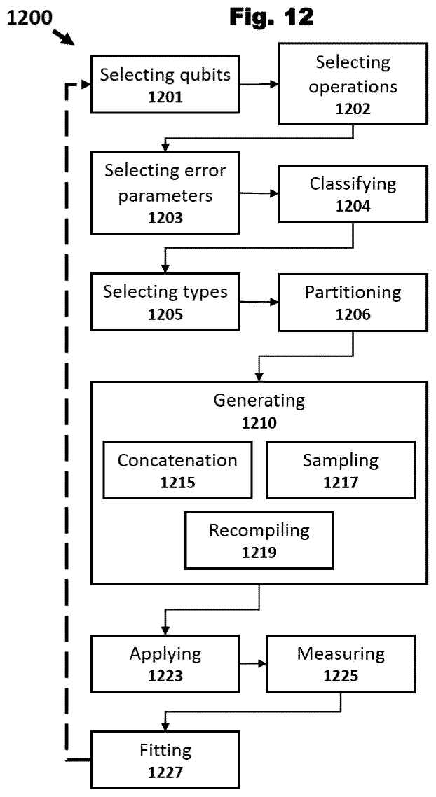

FIG. 12 illustrates a flowchart diagram of a computer implemented method 1200 for characterizing at least one target error parameter of implementation errors in a quantum logic operation g acting on a targeted set of qubits of a quantum processor, according to embodiments of the present disclosure. The method 1200 may include a step of selecting qubits 1201. Qubits to which quantum logic operations may be applied, in order to characterize implementation errors, may be selected. The method 1200 may include a step of selecting quantum logic operations 1202. At least one quantum logic operation, for which at least one target implementation error may be characterized, may be selected. The method 1200 may include a step of selecting at least one target error parameter 1203. The method 1200 may include a step of classifying the at least one target error parameter 1203. The at least one target error parameter may be classified according to e.g., coherent/dissipative, over-rotation/not-over-rotation.

The method 1200 may include a step of selecting types of characterization sequences 1206. A selection may be made, between characterization sequences that may include dynamical decoupling sequences, to characterization sequences that may include twirling sequences. The selection may be performed for each target error parameter included in the at least one target error parameter. The method 1200 may include a step of partitioning the qubits 1206. The qubits of the quantum processor may be partitioned to qubit-sets that may indicate which target error parameters may be characterized in parallel.

The method 1200 may include a step of generating an at least one characterization sequence 1210. The step of generating an at least one characterization sequence 1210 may include performing concatenations 1215, in order to obtain a recursively concatenated germ. The step of generating an at least one characterization sequence 1210 may include randomly sampling quantum operations 1217. For example, randomly sampling refocusing sequences and/or randomly sampling Pauli operators. Randomly sampling quantum operations 1217 may be performed in order to obtain twirling sequences. The step of generating an at least one characterization sequence 1210 may include recompiling the at least one characterization sequence 1219.

The method 1200 may include a step of applying the at least one characterization sequence 1223. The method 1200 may include a step of measuring the qubits 1225. The at least one characterization sequence may be applied to the qubits of the quantum processing unit, and a state of the qubits may be measured using a measurement apparatus of the quantum processor. The steps of applying the at least one characterization sequence 1223 measuring the qubits 1225 may be repeated in order to collect a set of measurement values.

The method 1200 may include a step of fitting the measurement results to a model 1227. A value of the at least one target error parameter may be computed by fitting a model to the set of measurement values.

In some embodiments, the method 1200 may be repeated (represented by a dashed line). The method 1200 may be repeated one or more times. The method 1200 may be repeated, for example, with a selection of other qubits, other quantum logic operations, other target error parameters, and different characterization sequences.

In some embodiments, the method 1200 may include updating a sequence-library. A characterization sequence, that may be generated at the step of generating an at least one characterization sequence 1210, may be added to a collection of characterization sequences. The collection of characterization sequences may be referred to as a “sequence-library”. Having a sequence-library may benefit the method 1200 by reducing a running time of the method 1200. Some of the characterization sequences, that the method 1200 may use, may be provided by the sequence-library, thereby avoiding unnecessary re-generation of characterization sequences.

It is noted that methods disclosed herein may be “deferred”. That is, referring to FIG. 2, the step of generating at least one characterization sequence S 210 may be performed independently of the step of characterizing the at least one target error parameter θ 220. For example, the step of generating at least one characterization sequence S 210 may be performed by a vendor of quantum circuits. The vendor may supply the at least one characterization sequence S 213 to a user, e.g., as a sequence-library. The user may perform the step of characterizing the at least one target error parameter θ 220, using the at least one characterization sequence S 213.

Methods disclosed herein may be used for calibrating quantum operations. An at least one characterization value of the quantum logic operation g may be obtained. The at least one characterization value may be obtained by characterizing the quantum logic operation g using a method disclosed herein. The at least one characterization value may not necessarily be an error parameter of the quantum logic operation g. For example, the at least one characterization value may be an angle of rotation or a coefficient of a KAK decomposition.

The quantum logic operation g may be configured for performing a predefined action on the targeted set of qubits. Configuring the quantum logic operation g may be performed by adjusting at least one pulse parameter of the quantum logic operation g, according to the at least one characterization value. For example, a pulse duration of an RF signal, that may be applied to a qubit, may be shortened or lengthened. The pulse duration may be set according to a difference between an angle of rotation that may be a characterization value, and a predefined angle of rotation that may be desired. Other examples for pulse parameters may include a pulse shape, a pulse amplitude, and a frequency spectrum.

Configuring the quantum logic operation g may be in order to correct implementation errors. In other words, configuring the quantum logic operation g may include correcting at least one implementation error in said quantum logic operation g.

It is noted that calibration may not necessarily be correction of errors. In some embodiments, a new quantum operation may be obtained by calibrating an available quantum operation. For example, a π/2-rotation gate may be characterized. A pulse parameter may be adjusted to a desired so as to obtain a π/4-rotation gate.

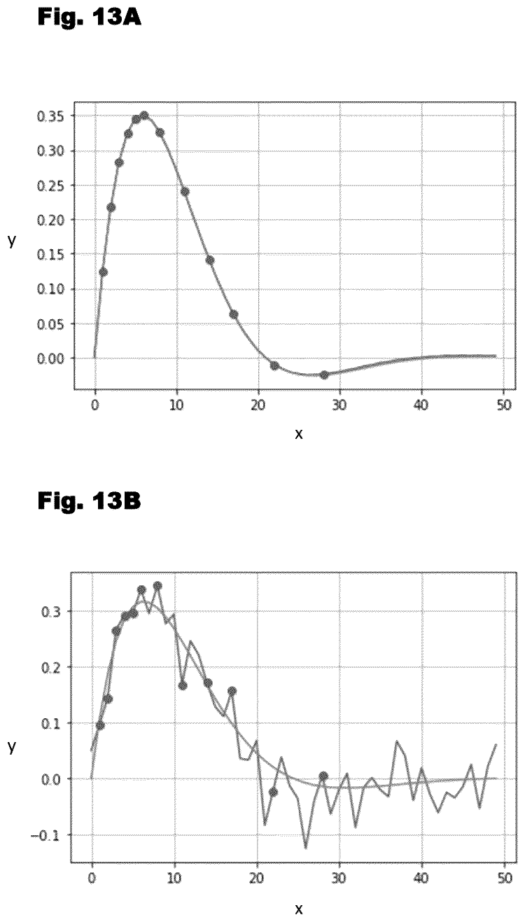

FIG. 13A-13B show graphs illustrating model-fitting in a method according to embodiments of the present disclosure.

A method according to the present disclosure, was simulated on a classical

$${e}^{- \frac{i}{2} {ασ}_{ZX}} ,$$

computer. A simulated quantum processor has two qubits. A two-qubit gate where α=π/6, was characterized. The target error parameter was a Pauli generator term Pₜ=σ_{ZY}, having a coefficient c_{ZY}. The Pauli generator term Pₜ is distinct from over-rotation.

The refocusing sequences were dynamical decoupling sequences. The refocusing sequences were A=σ_{XX}, B=σ_{Z1}, C=σ_{IY}. It is noted that these dynamical decoupling sequences can attenuate (reduce) crosstalk.

A recursively concatenated germ was built using the dynamical decoupling sequences. The number of concatenations was n=3. The recursively concatenated germ and the subsequences are G₁=gAgA, G₂=G₁AG₁A, G₃=G₂BG₂C.

Fiducial operations were included in the characterization sequences. The preparation Pauli state was Pₚ=σ_{XZ}, the measurement Pauli was Pₘ=σ_{ZZ}. Accordingly, a state preparation fiducial operation was Fₚ=Y_{π/2}⊗I, and a measurement fiducial operation was Fₘ=X_{π/2}⊗X_{π/2}.

The characterization sequences were S(N)=FₚG₃^{N}Fₘ, where N denotes the number of germs included in a characterization sequence. The number of germs used were N=1 . . . 6, 8, 11, 14, 17, 22, 29.

The characterization sequences were applied to the quantum processor, and the qubits were measured. The measured value was fitted to a function ƒ(N)=e^{-γN}e^{-τN}^{²} sin(θN). The parameters θ, γ, τ relate to coherent implementation errors, Markovian dissipation implementation errors, and non-Markovian dissipation implementation errors, respectively.

The target error parameter was then computed by c_{ZY}=0/(2N_{g}sinc(α)), where (2sinc(α)) is the transfer function. N_{g} denotes the number of instances of the quantum logic operation g in the recursively concatenated germ. For G₃ in the simulation, N_{g}=8.

FIG. 13A shows the model-fitting without statistical errors. That is, in the limit of applying each characterization sequence infinite times. FIG. 13B shows the model-fitting with statistical errors, where each characterization sequence was applied 500 times. In both figures, the x axis corresponds the number of germs included in a characterization sequence. The y axis corresponds the average measurement result [symbol] σ_{ZZ} [symbol] .

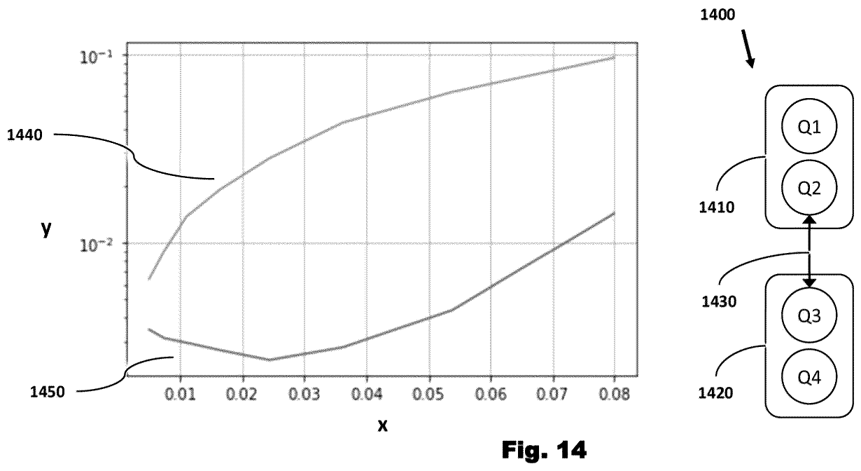

FIG. 14 show graphs demonstrating the performance of a method for characterizing errors in a quantum processor, according to the present disclosure, in comparison to methods for characterizing errors in a quantum processor, known in the art.

A method according to the present disclosure, and a method known in the art, were simulated on a classical computer. A simulated quantum processor 1400 has four qubits Q1 to Q4. Qubits Q2 and Q3 may have crosstalk 1430. Qubits Q1 Q2 form a first qubit-subset 1410. Qubits Q3 Q4 form a second qubit-subset 1420. The same quantum logic operation and the same noise model were used for both the method according to the present disclosure, and the method known in the art.

On each qubit-subset 1410 1420, a gate

$${e}^{- \frac{i}{2} {ασ}_{ZX}}$$

gate was characterized. The noise model excludes dissipative noise. Each point in the graphs was obtained by averaging 10 different values of α∈[0, π/2], each having 20 different realizations (200 realizations in total). Both characterization protocols use 10 points for fitting. That is, that are 10 points of amplification lengths l=1 to l=10, each with 1000 shots.

The x axis shows the standard deviation of the random Pauli parameters of the simulated layer (standard deviation of the crosstalk values). The y axis shows the averaged absolute error in estimation of the σ_{ZY} term. Graph 1440 represents the method known in the art. Graph 1450 represents the method according to the present disclosure.

Graph 1450 shows a lower error in estimating the σ_{ZY} term, in comparison to graph 1440. The method according to the present disclosure is crosstalk-aware, namely, it accounts for, and thus compensates for (eliminates) the first order contribution of the crosstalk. When crosstalk does not exist, both characterization protocols may have the same error shown in graph 1450.

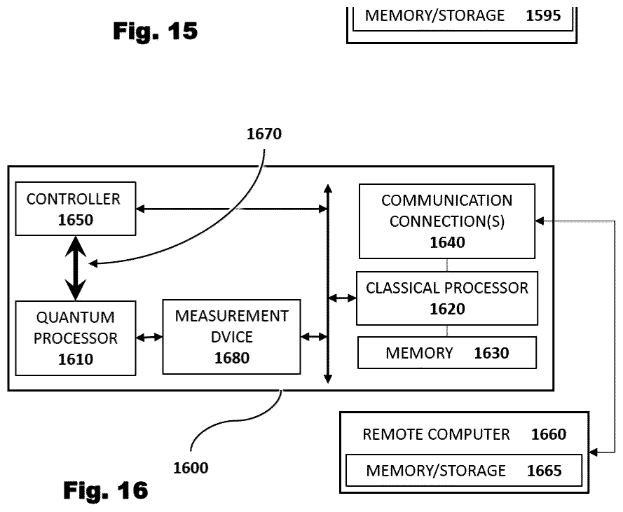

FIG. 15 and the following discussion are intended to provide a brief, general description of an exemplary computing environment in which the disclosed technology may be implemented. Although not required, the disclosed technology is described in the general context of computer executable instructions, such as program modules, being executed by a personal computer (PC). Generally, program modules include routines, programs, objects, components, data structures, etc., that perform particular tasks or implement particular abstract data types. Moreover, the disclosed technology may be implemented with other computer system configurations, including handheld devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 15, an exemplary system for implementing the disclosed technology includes a general purpose (classical) computing device in the form of an exemplary conventional PC 1500, including one or more processing units 1510, a system memory 1520, and a system bus 1530 that couples various system components including the system memory 1520 to the one or more processing units 1510. The system bus 1530 may be any of several types of bus structures including a memory bus or memory controller, a peripheral bus, and/or a local bus using any of a variety of bus architectures. The exemplary system memory 1520 includes read only memory (ROM) 1522 and random-access memory (RAM) 1527. A basic input/output system (BIOS) 1525, containing the basic routines that help with the transfer of information between elements within the PC 1500, is stored in ROM 1522. As shown in FIG. 15, the system memory 1520 may store computer-executable instructions for performing any of the disclosed techniques (e.g., sending instructions to quantum computer for applying characterization gate sequences and neighboring gate sequences to a subset of qubits, measuring outcomes, collecting frequencies, computing model parameters) in respective memory portions (shown generally as executable software 1529 for performing any embodiment of the disclosed synthesis techniques).

The exemplary PC 1500 further includes one or more storage devices 1540, such as a hard disk drive for reading from and writing to a hard disk, a magnetic disk drive for reading from or writing to a removable magnetic disk, and/or an optical disk drive for reading from or writing to a removable optical disk (such as a CD-ROM or other optical media). Such storage devices can be connected to the system bus 1530 by a hard disk drive interface, a magnetic disk drive interface, and/or an optical drive interface, respectively. The drives and their associated computer readable media provide nonvolatile storage of computer-readable instructions, data structures, program modules, and other data for the PC 1500. Other types of computer-readable media which can store data that is accessible by a PC, such as magnetic cassettes, flash memory, digital video disks, CDs, DVDs, RAMS, NVRAMs, ROMs, and the like, may also be used in the exemplary operating environment. As used herein, the terms storage, memory, and computer-readable media may not include or encompass propagating carrier waves or signals per se.

A number of program modules may be stored in the storage devices 1540, including an operating system, one or more application programs, other program modules, and program data. Storage of results of quantum measurements and instructions for obtaining such measurements (and/or instructions for performing any embodiment of the disclosed technology) can be stored in the storage devices 1540. A user may enter commands and information into the PC 1500 through one or more input devices 1550 such as a keyboard and a pointing device such as a mouse. Other input devices may include a digital camera, microphone, joystick, game pad, satellite dish, scanner, or the like. These and other input devices are often connected to the one or more processing units 1510 through a serial port interface that is coupled to the system bus 1530, but may be connected by other interfaces such as a parallel port, game port, or universal serial bus (USB). A monitor 1580 or other type of display device is also connected to the system bus 1530 via an interface, such as a video adapter. Other peripheral output devices 1560, such as speakers and printers (not shown), may be included. In some cases, a user interface is displayed so that a user can input a circuit for synthesis, and verify successful synthesis.

The PC 1500 may operate in a networked environment using logical connections to one or more remote computers, such as a remote computer 1590. In some examples, one or more network or communication connections 1570 are included. The remote computer 1590 may be another PC, a server, a router, a network PC, or a peer device or other common network node, and typically includes many or all of the elements described above relative to the PC 1500, although only a memory storage device 1595 has been illustrated in FIG. 15. The personal computer 1500 and/or the remote computer 1590 can be connected to a local area network (LAN) and a wide area network (WAN). Such networking environments are commonplace in offices, enterprise-wide computer networks, intranets, and the Internet.

When used in a LAN networking environment, the PC 1500 is connected to the LAN through a network interface. When used in a WAN networking environment, the PC 1500 typically includes a modem or other means for establishing communications over the WAN, such as the Internet. In a networked environment, program modules depicted relative to the personal computer 1500, or portions thereof, may be stored in the remote memory storage device or other locations on the LAN or WAN. The network connections shown are exemplary, and other means of establishing a communications link between the computers may be used.

With reference to FIG. 16, an exemplary system for implementing the disclosed technology includes computing environment 1600, The environment includes one or more quantum processing unit(s) 1610 including one or more monitoring/measuring device(s). The quantum processing unit(s) execute quantum circuits that are provided by a classical processing unit 1620. The quantum circuits are downloaded into or used to program or configure the quantum processing unit(s) 1610 (e.g., via control lines (quantum bus) 1670). Procedures according to any of the disclosed embodiments (e.g., a high-level description of the set of quantum circuits to be applied to a qubit patch and neighboring qubits) may be stored in a memory 1630.

With reference to FIG. 16, the high-level description of a quantum software may be translated into quantum circuits (e.g., sequences of quantum gates, or layers of gates acting in parallel on different qubits). Such high-level descriptions may be stored, as the case may be, on one or more external computers 1660 outside the computing environment 1600 utilizing one or more memory and/or storage device(s) 1665, then downloaded as necessary into the computing environment 1600 via one or more communication connection(s) 1640. Quantum circuits (according to any of the disclosed embodiments) are coupled to the quantum processor 1610.

The quantum processing unit(s) can be one or more of, but are not limited to: (a) a superconducting quantum computer; (b) an ion trap quantum computer; (c) a topological quantum computer using e.g., Majorana zero modes; (d) a photonic quantum computer; or (c) a neutral atom quantum computer. The sets of gates (e.g., using any of the disclosed embodiments) can be sent into (or otherwise applied to) the quantum processing unit(s) via control lines 1670 at a controller 1650. In the illustrated example, the desired quantum computing process is implemented with the aid of one or more controllers 1650 that are specially adapted to control a corresponding one of the quantum processor(s) 1610. The classical processor 1620 can further interact with measuring/monitoring devices (e.g., readout devices) 1680 to help control and implement the desired quantum computing process (e.g., by reading or measuring out data results from the quantum processing units once available, etc.).

Therefore, casting into a language of clauses, the present disclosure provides methods and systems according to, but not limited to, the following clauses:
Clause 1: A computer implemented method for characterizing at least one target error parameter of implementation errors in a quantum logic operation g acting on a targeted set of qubits of a quantum processor, the method comprising:
   (a) generating at least one characterization sequence S configured for amplifying said at least one target error parameter, said at least one characterization sequence S comprises at least one refocusing sequence, wherein the at least one refocusing sequence is configured so that the characterization sequence reduces predefined generator terms including crosstalk between said targeted set of qubits and another set of qubits of the quantum processor;
   (b) characterizing said at least one target error parameter using said at least one characterization sequence in a characterization protocol.
Clause 2: As recited in clause 1, wherein characterizing the at least one target error parameter comprises:
   (a) applying the at least one characterization sequence S to the quantum processor;
   (b) measuring the targeted set of qubits using a measurement apparatus of said quantum processor, thereby obtaining a set of measurement values;
   (c) computing a value of said at least one target error parameter, by fitting a model to said set of measurement values.
Clause 3: As recited in any one of clauses 1 to 2, wherein said at least one characterization sequence S is configured for reducing predefined coherent error generator terms in said targeted set of qubits.
Clause 4: As recited in any one of clauses 1 to 3, wherein said at least one refocusing sequence is a dynamical decoupling sequence.
Clause 5: As recited in any one of clauses 1 to 3, wherein said at least one refocusing sequence is a twirling sequence.
Clause 6: As recited in any one of clauses 1 to 5, wherein said at least one target error parameter is a Pauli generator term Pₜ.
Clause 7: As recited in clause 6, wherein said at least one characterization sequence S is configured to eliminate predefined Pauli generator terms of said implementation errors distinct from the at least one target error parameter.
Clause 8: As recited in any one of the preceding clauses, wherein said method characterizes a single target error parameter of implementation errors in the quantum logic operation g.
Clause 9: As recited in any one of the preceding clauses, wherein said at least one characterization sequence S is configured to reduce a magnitude measure of said crosstalk.
Clause 10: As recited in any one of the preceding clauses, wherein said at least one characterization sequence S is configured to eliminate at least a first-order error of implementation errors distinct from the at least one target error parameter.
Clause 11: As recited in any one of the preceding clauses, wherein said at least one characterization sequence S is configured for characterizing dissipation implementation errors, said dissipation implementation errors being any one of Markovian dissipation implementation errors, and non-Markovian dissipation implementation errors.
Clause 12: As recited in any one of the preceding clauses, comprising recompiling said at least one characterization sequence S.
Clause 13: As recited in any one of the preceding clauses, wherein said at least one characterization sequence S comprises at least one germ.
Clause 14: As recited in clause 13, wherein said at least one germ is a recursively concatenated germ.
Clause 15: As recited in any one of the preceding clauses, wherein the at least one refocusing sequences includes a set of refocusing sequences and said at least one characterization sequence S includes a recursively concatenated germ obtained by computing a predefined number n of concatenations Gₖ₊₁=ΠₘGₖβₘ^{(k)}, wherein k=0, 1, . . . , n−1, wherein, (k) are refocusing sequences of said set of refocusing sequences and G₀=g, g being said quantum logic operation.
Clause 16: As recited in any one of the preceding clauses, wherein said at least one characterization sequence S comprises at least one fiducial operation.
Clause 17: As recited in clause 16 as dependent on clause 3, wherein:
   (a) said at least one fiducial operation comprises state preparation operations configured for setting a state of said set of qubits to a preparation Pauli state Pₚ;
   (b) said at least one fiducial operation comprises measuring said set of qubits according to a measurement Pauli Pₘ.
Clause 18: As recited in clause 17, wherein said preparation Pauli state Pₚ, measurement Pauli Pₘ, and said Pauli generator term Pₜ, span an algebra isomorphic to the SU(2) Lie algebra.
Clause 19: As recited in any one of clauses 17 to 18, wherein said preparation Pauli state Pₚ and measurement Pauli Pₘ are configured for increasing a sensitivity of said least one characterization sequence S to said at least one error parameter.
Clause 20: As recited in any one of clauses 16 to 19, wherein said at least one fiducial operation comprises a gate layer.
Clause 21: As recited in any one of clauses 6 to 20, wherein said at least one refocusing sequence commutes with said Pauli generator term Pₜ.
Clause 22: As recited in any one of the preceding clauses, wherein said quantum logic operation g is a single-qubit operation; or wherein said quantum logic operation g is a two-qubit operation, and wherein a KAK decomposition of the quantum logic operation g comprises any of one generator, two generators, and three generators.
Clause 23: As recited in any one of the preceding clauses, wherein said quantum logic operation g is a two-qubit operation, and wherein:
   (a) said Pauli generator term Pₜ anti-commutes with at least one generator of a KAK decomposition of an ideal version of said quantum logic operation g;
   (b) a sum of coefficients is greater than

$$\frac{3 π}{4} ,$$

said coefficients corresponding to said at least one KAK generator anti-commuting with said Pauli generator term Pₜ; and
(c) said at least one refocusing sequence comprises at least one secondary refocusing sequence, said at least one secondary refocusing sequence commuting with all commutators of said Pauli generator term Pₜ and generators of said KAK decomposition of an ideal version of said quantum logic operation g.
Clause 24: As recited in any one of clauses 14 to 23, wherein said Pauli generator term Pₜ is distinct from an over-rotation term and said recursively concatenated germ comprises at least n concatenation steps, and wherein said at least one characterization sequence S is configured to eliminate a fraction of 1-2⁻ⁿ of Pauli generator terms of said implementation errors.
Clause 25: As recited in any one of clauses 14 to 24, wherein said Pauli generator term Pₜ is distinct from an over-rotation term and a primary refocusing sequence anti-commutes with a corresponding Pauli generator term of an ideal version of said quantum logic operation g.
Clause 26: As recited in any one of clauses 14 to 22, wherein said Pauli generator term Pₜ is an over-rotation term and said recursively concatenated germ comprises at least n concatenation steps, and wherein said at least one characterization sequence S is configured to eliminate a fraction of 1-2⁻⁽ⁿ⁺¹⁾ of Pauli generator terms of said implementation errors.
Clause 27: As recited in any one of clauses 24 or 26, wherein said at least one characterization sequence S is configured to isolate said Pauli generator term Pₜ of said implementation errors.
Clause 28: As recited in any one of clauses 26 to 27, wherein said at least one characterization sequence S comprises any of the germs G₀⁽¹⁾=gA, and G₁⁽¹⁾=BG₀⁽¹⁾CG₀⁽¹⁾, wherein said A, B, C being refocusing sequences.
Clause 29: As recited in any one of clauses 26 to 28, wherein said at least one characterization sequence S comprises any of the germs G₀⁽²⁾=gAgA, and G₁⁽²⁾=BG₀⁽²⁾CG₀⁽²⁾, wherein said A, B, C being refocusing sequences.
Clause 30: As recited in any one of clauses 24 to 25, or clause 27, wherein said at least one characterization sequence S comprises any of the germs G₀⁽³⁾=gAgA, G₁⁽³⁾=G₀⁽³⁾AG₀⁽³⁾A, G₂⁽³⁾=BG₁⁽³⁾CG₁⁽³⁾, and G₃⁽³⁾=G₁⁽³⁾BG₁⁽³⁾C, wherein said A, B, C being refocusing sequences.
Clause 31: As recited in any one of the preceding clauses, wherein said at least one characterization sequence S comprises refocusing sequences randomly sampled for each application of the at least one characterization sequence S.
Clause 32: As recited in any one of clauses 3 to 25, or clause 31, wherein said Pauli generator term Pₜ is distinct from an over-rotation term, wherein said at least one characterization sequence S comprises at least one subsequence G⁽⁴⁾=PgDgDP, wherein:
   (a) said P being a randomly sampled Pauli operator; and
   (b) said D being a refocusing sequence commuting with said Pauli generator term Pₜ, and anti-commuting with a corresponding Pauli generator term of an ideal version of said quantum logic operation g.
Clause 33: As recited in any one of clauses 3 to 23, or any one of clauses 26 to 29, wherein said Pauli generator term Pₜ is an over-rotation term, wherein said at least one characterization sequence S comprises at least one subsequence G⁽⁵⁾=PgP, wherein said P being a randomly sampled Pauli operator commuting with said Pauli generator term Pₜ.
Clause 34: As recited in any one of the preceding clauses, applied to at least two quantum logic operations in parallel.
Clause 35: As recited in clause 34, wherein said at least two quantum logic operations operate on corresponding subsets of qubits, each of said corresponding subsets of qubits having no common qubit.
Clause 36: As recited in clause 35, wherein no crosstalk is present between each of said corresponding subsets of qubits.
Clause 37: As recited in any one of clauses 35 to 36, wherein each of said corresponding subsets of qubits is included in a corresponding hyperedge of an interaction hypergraph, wherein each of said corresponding hyperedges being unique for each of said corresponding subsets of qubits.
Clause 38: As recited in any one of clauses 34 to 37, wherein said quantum logic operation g is a gate layer or said at least one refocusing sequence comprises a gate layer.
Clause 39: A method for characterizing a quantum processor including a plurality of quantum logic operations, the method comprising applying a method according to any one of clauses 1 to 38 to at least one quantum logic operation included in the plurality of quantum logic operations of the quantum processor.
Clause 40: As recited in clause 39, wherein the quantum processor is described in terms of qudits in place of qubits.
Clause 41: A non-transient computer readable storage medium, storing computer instructions, wherein the computer instructions are used for causing a computer to execute the method according to any one of clauses 1 to 40.
Clause 42: A computer program product, comprising a computer program, wherein the computer program, when executed by a computer, implements the method according to any one of clauses 1 to 40.
Clause 43: A system comprising a computer and a quantum processor, the computer having gate-level or pulse-level access to the quantum processor, the system being configured to perform the method according to any one of clauses 1 to 40.
Clause 44: A system for characterizing implementation errors in a quantum logic operation g operating on a targeted set of qubits of a quantum processor, comprising a processor configured for executing computer-executable components stored in a memory, wherein the computer-executable components comprise:
   (a) a sequence component, configured for generating at least one characterization sequence, said at least one characterization sequence including at least one refocusing sequence and said quantum logic operation g, the at least one characterization sequence is configured for amplifying at least one target error parameter, and the at least one refocusing sequence is configured for reducing predefined crosstalk Pauli terms between said targeted set of qubits and another set of qubits of the quantum processor; and
   (b) a characterization component, configured for characterizing errors in said quantum logic operation g, using said sequence.
Clause 45: As recited in clause 44, wherein said at least one characterization sequence is configured for reducing predefined Pauli generator terms in said targeted set of qubits.
Clause 46: As recited in any one of clauses 44 to 45, wherein said at least one refocusing sequence is a dynamical decoupling sequence.
Clause 47: As recited in any one of clauses 44 to 45, wherein said at least one refocusing sequence is a twirling sequence.
Clause 48: As recited in any one of clauses 44 to 47, wherein said at least one target error parameter is a Pauli generator term Pₜ.
Clause 49: As recited in clause 48, wherein said at least one refocusing sequence commutes with said Pauli generator term Pₜ.
Clause 50: As recited in clause 48 or clause 49, wherein a first refocusing sequence included in said at least one characterization sequence anti-commutes with a Pauli generator term of an ideal version of said quantum logic operation g corresponding said Pauli generator term Pₜ.
Clause 51: As recited in any one of clauses 48 to 50, wherein said at least one refocusing sequence is configured to cut the link between a targeted subset of qubits and its neighbors.
Clause 52: A quantum circuit for use in characterizing implementation errors in a quantum logic operation g acting on a set of qubits, said quantum circuit comprises the quantum logic operation g and at least one refocusing sequence, wherein the quantum circuit is configured for amplifying at least one target error parameter, wherein the at least one refocusing sequence is configured for reducing predefined terms of a crosstalk between said set of qubits and a set of spectator qubits of the quantum processor.
Clause 53: As recited in clause 52, wherein said at least one characterization sequence is configured for reducing predefined generator terms in said targeted set of qubits.
Clause 54: As recited in any one of clauses 52 to 53, wherein said at least one refocusing sequence is a dynamical decoupling sequence.
Clause 55: As recited in any one of clauses 52 to 53, wherein said at least one refocusing sequence is a twirling sequence.
Clause 56: As recited in any one of clauses 52 to 55, wherein said at least one target error parameter is a Pauli generator term Pₜ.
Clause 57: As recited in clause 56, wherein said Pauli generator term Pₜ is not an over-rotation Pauli generator term, the quantum circuit comprises any of the germs G₀⁽¹⁾=gAgA, G₁⁽¹⁾=G₀⁽¹⁾AG₀⁽¹⁾A, G₂⁽¹⁾=BG₁⁽¹⁾CG₁⁽¹⁾, and G₃⁽¹⁾=G₁⁽¹⁾BG₁⁽¹⁾C, wherein said A, B, C being refocusing sequences.
Clause 58: As recited in clause 56, wherein said Pauli generator term Pₜ is an over-rotation Pauli generator term, the quantum circuit comprises any of the germs G₀⁽²⁾=gA, G₁⁽²⁾=gAgA, G₂⁽²⁾=BG₁⁽²⁾CG₁⁽²⁾, G₃⁽²⁾=BG₁⁽²⁾CG₁⁽²⁾ wherein said A, B, C being refocusing sequences.
Clause 59: As recited in any one of clauses 56 to 58, comprising at least one recursively concatenated germ.
Clause 60: As recited in clause 59, wherein the at least one refocusing sequences includes a set of refocusing sequences, wherein said recursively concatenated germ is defined by a predefined number n of concatenations Gₖ₊₁=ΠₘGₖβₘ^{(k)}, wherein k=0, 1, . . . , n−1, wherein G₀=g, wherein βₘ^{(k)} are refocusing sequences included in said set of refocusing sequences.
Clause 61: As recited in clause 56, wherein said Pauli generator term Pₜ is not an over-rotation Pauli generator term, the quantum circuit comprises at least one subsequence G⁽³⁾=PgDgDP, wherein:
   (a) said P being a randomly sampled Pauli operator commuting with said Pauli term Pₜ; and
   (b) said D being a refocusing sequence commuting with said Pauli generator term Pₜ, and anti-commuting with a corresponding Pauli generator term of an ideal version of said quantum logic operation g.
Clause 62: As recited in clause 56, wherein said Pauli generator term Pₜ is an over-rotation Pauli generator term, the quantum circuit comprises at least one subsequence G⁽⁴⁾=PgP, wherein said P being a randomly sampled Pauli operator commuting with said Pauli term Pₜ.
Clause 63: A computer implemented method for calibrating a quantum logic operation g acting on a targeted set of qubits of a quantum processor, the method comprising:
   (a) obtaining at least one characterization value of said quantum logic operation g by characterizing said quantum logic operation g using a method according to any one of clauses 1 to 38;
   (b) configuring said quantum logic operation g for performing a predefined action on said targeted set of qubits, by adjusting at least one pulse parameter of said quantum logic operation g, according to said at least one characterization value.
Clause 64: As recited in clause 63, wherein adjusting at least one pulse parameter comprises adjusting at least one of a pulse shape, a pulse amplitude, and a frequency spectrum.
Clause 65: As recited in any one of clauses 63 to 64, wherein configuring said quantum logic operation g includes correcting at least one implementation error in said quantum logic operation g.
Clause 66: The method as recited in any one of clauses 31 to 40 as dependent on clause 23, wherein:
   (a) said Pauli generator term Pₜ is distinct from an over-rotation term;
   (b) said at least one characterization sequence S comprises at least one subsequence G⁽⁶⁾=PG^{(n≤3)}P, wherein:
      i) said P being a Pauli operator which is randomly sampled from a set of all the Pauli operators commuting with either Pₜ or the commutator of Pₜ and the ideal gate's KAK decomposition; and
      ii) G^{(n≤3)} is any one of: G⁽⁰⁾=g, and a subsequence as recited in clauses 28-30.

Having described and illustrated the principles of the disclosed technology with reference to the illustrated embodiments, it will be recognized that the illustrated embodiments can be modified in arrangement and detail without departing from such principles. For instance, elements of the illustrated embodiments shown in software may be implemented in hardware and vice-versa. Also, the technologies from any example can be combined with the technologies described in any one or more of the other examples. It will be appreciated that procedures and functions such as those described with reference to the illustrated examples can be implemented in a single hardware or software module, or separate modules can be provided. The arrangements above are provided for convenient illustration, and other arrangements can be used.

1. A computer implemented method for characterizing at least one target error parameter of implementation errors in a quantum logic operation g acting on a targeted set of qubits of a quantum processor, the method comprising:
(a) generating at least one characterization sequence S configured for amplifying said at least one target error parameter, said at least one characterization sequence S comprises at least one refocusing sequence, wherein the at least one refocusing sequence is configured so that the characterization sequence reduces predefined generator terms including crosstalk between said targeted set of qubits and another set of qubits of the quantum processor;
(b) characterizing said at least one target error parameter using said at least one characterization sequence in a characterization protocol.

2. The method according to claim 1, wherein characterizing the at least one target error parameter comprises:
(a) applying the at least one characterization sequence S to the quantum processor;
(b) measuring the targeted set of qubits using a measurement apparatus of said quantum processor, thereby obtaining a set of measurement values;
(c) computing a value of said at least one target error parameter, by fitting a model to said set of measurement values.

3. The method according to claim 1, wherein:
(a) said at least one characterization sequence S is configured for reducing predefined coherent error generator terms in said targeted set of qubits;
(b) the method characterizes a single target error parameter of implementation errors in the quantum logic operation g;
(c) said at least one target error parameter is a Pauli generator term Pₜ; said at least one characterization sequence S is configured to eliminate predefined Pauli generator terms of said implementation errors distinct from the at least one target error parameter; and
(d) said at least one refocusing sequence commutes with said Pauli generator term Pₜ.

4. The method according to claim 1, wherein said at least one refocusing sequence is any of: a dynamical decoupling sequence, and a twirling sequence.

5. The method according to claim 1, wherein said at least one characterization sequence S is configured to any of: reducing a magnitude measure of said crosstalk, and eliminating at least a first-order error of implementation errors distinct from the at least one target error parameter.

6. The method according to claim 1, wherein the at least one refocusing sequences includes a set of refocusing sequences, and wherein said at least one characterization sequence S comprises at least one recursively concatenated germ obtained by computing a predefined number n of concatenations Gₖ₊₁=ΠₘGₖβₘ^{(k)}, wherein k=0, 1, . . . , n−1, wherein, βₘ^{(k)} are refocusing sequences included in said set of refocusing sequences and G₀=g, g being said quantum logic operation.

7. The method according to claim 3, wherein said at least one characterization sequence S comprises at least one fiducial operation, and wherein:
(a) said at least one fiducial operation comprises state preparation operations configured for setting a state of said set of qubits to a preparation Pauli state Pₚ;
(b) said at least one fiducial operation comprises measuring said set of qubits according to a measurement Pauli Pₘ;
(c) said preparation Pauli state Pₚ and measurement Pauli Pₘ are configured for increasing a sensitivity of said least one characterization sequence S to said at least one error parameter; and
(d) said preparation Pauli state Pₚ, measurement Pauli Pₘ, and said Pauli generator term Pₜ, span an algebra isomorphic to the SU(2) Lie algebra.

8. The method according to claim 1, wherein said quantum logic operation g is a two-qubit operation, and wherein:
(a) said Pauli generator term Pₜ anti-commutes with at least one generator of a KAK decomposition of an ideal version of said quantum logic operation g;
(b) a sum of coefficients is greater than
$$\frac{3 π}{4} ,$$
said coefficients corresponding to said at least one KAK generator anti-commuting with said Pauli generator term Pₜ; and
(c) said at least one refocusing sequence comprises at least one secondary refocusing sequence, said at least one secondary refocusing sequence commuting with all commutators of said Pauli generator term Pₜ and generators of said KAK decomposition of an ideal version of said quantum logic operation g.

9. The method according to claim 6, wherein any one of the following:
(a) said Pauli generator term Pₜ is distinct from an over-rotation term and wherein:
i) said recursively concatenated germ comprises at least n concatenation steps;
ii) said Pauli generator term Pₜ is distinct from an over-rotation term and a primary refocusing sequence anti-commutes with a corresponding Pauli generator term of an ideal version of said quantum logic operation g; and
iii) said at least one characterization sequence S is configured to eliminate a fraction of 1-2⁻ⁿ of Pauli generator terms of said implementation errors;
(b) said Pauli generator term Pₜ is an over-rotation term and said recursively concatenated germ comprises at least n concatenation steps, and wherein said at least one characterization sequence S is configured to eliminate a fraction of 1-2⁻⁽ⁿ⁺¹⁾ of Pauli generator terms of said implementation errors;
wherein said at least one characterization sequence S is preferably configured to isolate said Pauli generator term Pₜ of said implementation errors.

10. The method according to claim 9, wherein any one of the following:
(a) said Pauli generator term Pₜ is an over-rotation term, and said at least one characterization sequence S comprises any one of the germs G₀⁽¹⁾=gA, G₁⁽¹⁾=BG₀⁽¹⁾CG₀⁽¹⁾, and G₀⁽²⁾=gAgA, and G₁⁽²⁾=BG₀⁽²⁾CG₀⁽²⁾ wherein said A, B, C being refocusing sequences; and
(b) said Pauli generator term Pₜ is distinct from an over-rotation term, and said at least one characterization sequence S comprises any of the germs G₀⁽³⁾=gAgA, G₁⁽³⁾=G₀⁽³⁾AG₀⁽³⁾A, G₂⁽³⁾=BG₁⁽³⁾CG₁⁽³⁾, and G₃⁽³⁾=G₁⁽³⁾BG₁⁽³⁾C, wherein said A, B, C being refocusing sequences.

11. The method according to claim 3, wherein any one of the following:
(a) said Pauli generator term Pₜ is distinct from an over-rotation term, wherein said at least one characterization sequence S comprises at least one subsequence G⁽⁴⁾=PgDgDP, and wherein:
i) said P being a randomly sampled Pauli operator; and
ii) said D being a refocusing sequence commuting with said Pauli generator term Pₜ, and anti-commuting with a corresponding Pauli generator term of an ideal version of said quantum logic operation g;
(b) said Pauli generator term Pₜ is an over-rotation term, wherein said at least one characterization sequence S comprises at least one subsequence G⁽⁵⁾=PgP, wherein said P being a randomly sampled Pauli operator commuting with said Pauli generator term Pₜ.

12. The method according to claim 1, applied to at least two quantum logic operations in parallel, wherein said at least two quantum logic operations operate on corresponding subsets of qubits, each of said corresponding subsets of qubits having no common qubit.

13. The method according to claim 12, wherein no crosstalk is present between each of said corresponding subsets of qubits.

14. The method according to claim 12, wherein each of said corresponding subsets of qubits is included in a corresponding hyperedge of an interaction hypergraph, wherein each of said corresponding hyperedges being unique for each of said corresponding subsets of qubits.

15. A non-transient computer readable storage medium, storing computer instructions, wherein the computer instructions are used for causing a computer to execute the method according to claim 1.

16. A system for characterizing implementation errors in a quantum logic operation g operating on a targeted set of qubits of a quantum processor, comprising a processor configured for executing computer-executable components stored in a memory, wherein the computer-executable components comprise:
(a) a sequence component, configured for generating at least one characterization sequence, said at least one characterization sequence including at least one refocusing sequence and said quantum logic operation g, the at least one characterization sequence is configured for amplifying at least one target error parameter, and the at least one refocusing sequence is configured for reducing predefined crosstalk Pauli terms between said targeted set of qubits and another set of qubits of the quantum processor; and
(b) a characterization component, configured for characterizing errors in said quantum logic operation g, using said sequence.

17. The system according to claim 16, wherein said at least one target error parameter is a Pauli generator term Pₜ, and wherein said at least one characterization sequence is configured for reducing predefined Pauli generator terms in said targeted set of qubits.

18. The system according to claim 16, wherein said at least one refocusing sequence is any of: a dynamical decoupling sequence, and a twirling sequence.

19. The system according to claim 17, wherein said at least one refocusing sequence commutes with said Pauli generator term Pₜ.

20. The system according to claim 17, wherein a first refocusing sequence included in said at least one characterization sequence anti-commutes with a Pauli generator term of an ideal version of said quantum logic operation g corresponding said Pauli generator term Pₜ.
